(19) United States
(12) Patent Application Publication
(10) Pub. No.: US 2014/0189569 A1
(43) Pub. Date: Jul. 3, 2014

(54) USER INTERFACE FOR TEXT INPUT ON THREE DIMENSIONAL INTERFACE

(71) Applicant: Syntellia, Inc., San Francisco, CA (US)

(72) Inventors: Kosta Eleftheriou, San Francisco, CA (US); Ioannis Verdelis, San Francisco, CA (US)

(73) Assignee: Syntellia, Inc., San Francisco, CA (US)

(21) Appl. No.: 14/200,696

(22) Filed: Mar. 7, 2014

Related U.S. Application Data
(63) Continuation-in-part of application No. 13/531,200, filed on Jun. 22, 2012.
Application No. 13/531,200 is a continuation-in-part of application No. 13/747,700, filed on Jan. 23, 2013.
(60) Provisional application No. 61/804,124, filed on Mar. 21, 2013.
(60) Provisional application No. 61/508,829, filed on Jul. 18, 2011.
(60) Provisional application No. 61/598,163, filed on Feb. 13, 2012.
(60) Provisional application No. 61/665,121, filed on Jun. 27, 2012.

(51) Int. Cl. G06F 3/0488; G06F 3/0481; G06F 3/0485

(52) U.S. Cl. CPC G06F 3/04886; G06F 3/0485; G06F 3/04815
USPC 715/773

(57) ABSTRACT

A three dimensional data input system includes a space sensor that can input commands and text based upon user gestures within a three dimensional space. The three dimensional space can include a virtual keyboard and the system identifies words input as a set of points input by a user on the virtual keyboard. The intended word is identified by determining an origin and points associated with letters on a log polar coordinate system. The log distances and angles of the points are then compared to log distances and angles for known words stored in a computer memory. The known word having the log distances and angles that most closely match the input points is identified as the intended word.

### CROSS REFERENCE TO RELATED APPLICATIONS

This application claims priority to U.S. Provisional Patent Application No. 61/804,124, “User Interface For Text Input On Three Dimensional Interface” filed Mar. 21, 2013 and this application is a continuation-in-part of U.S. patent application Ser. No. 13/531,200, “Data Input System And Method For A Touch Sensor Input” filed on Jun. 22, 2012, which claims priority from U.S. Provisional Patent Application No. 61/508,829, filed Jul. 18, 2011. This application is also a continuation-in-part of U.S. patent application Ser. No. 13/747,700, “User Interface For Text Input” filed Jan. 23, 2013 which claims priority to U.S. Provisional Applications No. 61/598,163, filed Feb. 13, 2012 and U.S. Provisional Applications No. 61/665,121, filed Jun. 27, 2012. U.S. patent application Ser. Nos. 13/531,200, 13/747,700, 61/508,829, 61/598,163, 61/665,121 and 61/804,124 are hereby incorporated by reference in their entirety.

### FIELD OF INVENTION

This invention relates to user interfaces and in particular to text input.

### BACKGROUND OF THE INVENTION

The present invention relates to the domain of text input and text editing on a computer system via a virtual keyboard. With the advent of touch-screen technologies, user interface innovations have been necessary to achieve input of text in environments where a full hardware keyboard is not available. Mobile phones (such as the Apple iPhone, the Samsung Galaxy), tablet computers (such as the Apple iPad, or the Blackberry Playbook) as well as a range of mobile computers, PDAs, Smart Watches, satellite navigation assistants, home entertainment controllers have featured comprehensive typing systems.

In such devices featuring a touch-screen, it is common to emulate a “virtual keyboard” and to recognize screen gestures in order to achieve text input. In addition to virtual touch screen keyboards, a number of controllers have been released that are capable of tracking body movements for video games and computer input commands. Examples of such devices are the Microsoft Kinect controller, or the Leap Motion controller. These touch-less controllers can interface into existing computer systems and devices, as well as onto home entertainment systems, and gaming consoles. The controllers are able to track the movement of body parts, such as arms, legs, heads, or fingers, with varying degrees of accuracy. Such controllers give rise to new potential user interfaces for common computing functions, as they can be used to complement or replace device controllers available today, such as keyboards, mice, or touch-screens.

To date, typing text using touch-less controllers has been problematic. However, improvements in the accuracy of such controllers, as well as improvements in auto-correct technologies are now making it possible to type using a touch-less interface. The present invention describes a comprehensive user interface which can be used in a touch-less typing system, and which provides all the common functionality required for text entry in a simulated keyboard.

### SUMMARY OF THE INVENTION

The inventive system will detect tap gestures, as movements of the body part in a trajectory that intersects the virtual keyboard. When an intersection of the virtual keyboard is detected, the gesture recognizer will register a tap at the three dimensional coordinates (x, y, z) where the body part intersected the virtual keyboard. The inventive system may transpose these three dimensional coordinates into a normalized coordinate system representing a two dimensional coordinate system of a virtual keyboard, co-planar with the defined plane or region.

### BRIEF DESCRIPTION OF THE DRAWINGS

FIG. 1 illustrates a block diagram of the system components;

FIGS. 2 and 3 illustrate virtual keyboards in a three dimensional space;

FIGS. 4-15 illustrate user activity on a virtual keyboard in a three dimensional space used with mobile electronic devices;

FIG. 16 illustrates an optical sensor for detecting inputs in a three dimensional space;

FIG. 17, a flow chart of an embodiment of processing steps for determining an intended word from a set of touch points input into a detected three dimensional space;

FIGS. 18A-18D illustrate touch points on a virtual keyboard in a detected three dimensional space;

FIG. 19 illustrates radial values for an intended word and a candidate word on a graph;

FIG. 20 illustrates a plot of Δθ values with respect to each letter of a prospective word;

FIG. 21 illustrates a plot of weighted Δθ values for each letter of a prospective word;

FIGS. 22A-22C illustrate a graphical representation of the different weights applied to sequential points in an input word;

FIGS. 23 and 24 illustrate a virtual keyboard in a three dimensional space;

FIG. 25 illustrates a series of virtual keyboard input points on a radial coordinate system;

FIGS. 26-30 illustrate virtual keyboards in a three dimensional sensor detection space and used with mobile electronic devices;

FIG. 31 illustrates a vehicle dashboard embodiment of the three dimensional space user interface input system;

FIG. 32 illustrates a smartwatch embodiment of the three dimensional space user interface input system; and

FIG. 33 illustrates a smart glasses embodiment of the three dimensional space user interface input system.

### DETAILED DESCRIPTION

The present invention describes a device capable of recording body movements, such as a device connected to a Microsoft Kinect or Leap Motion controller. In other embodiments, the device may include an embedded controller with this functionality. In other embodiments, the inventive system may be provided as a software package and installed onto a hardware device already featuring a body tracking controller.

The device may feature other input controllers, such as a mouse, or a gaming controller. It may include output controllers for transmitting output signals to output devices such as a screen, a projector, or audio devices such as speakers or headphones. In some embodiments, the output controllers may be used to assist the inventive system by providing user feedback, such as displaying a virtual keyboard on a screen, or confirming the typed text to the user via the screen or audio feedback.

In different embodiments, the inventive system will feature modules that can function alone or together to allow users to input text through touch-less motion sensor devices. The modules may include: Gesture recognizing module, Typing controller module, Autocorrect module and Output module.

The inventive system can use these modules to recognize the user's input, provide some typing corrections to compensate for typing errors, and output the filtered text. For example, in an embodiment of the system, a user will move his arm, hand, or finger, so as to control the system. The input controller will register the body movements of the user. The gesture recognizing module will read the controller's input, and recognize a plurality of body movements as intended “gestures” of the user.

The inventive system can also provide inputs by detecting user gestures to assist typing a letter of word, adding a space character, invoking an auto-correct system, deleting a word or a character, adding punctuation, and changing suggestions of an auto-correct system. These detected gestures used to provide user inputs may be used in combination, or individually, by different embodiments of the inventive system. For example, these gestures can include “taps” on virtual buttons as the user's intent to press a specific letter button, and “swipes”, or finger movements on screen, to indicate typical keyboard functions such as that of actuating “space”, “backspace”, or “new line” functions. Examples of detectable virtual keyboard gestures are disclosed in co-pending U.S. patent application Ser. Nos. 13/471,454 and 11/027,385, 10/807,589 and U.S. Pat. No. 7,774,155 which are hereby incorporated by reference in their entirety.

These recognized gestures can be used to control the functions of a typing controller, which will translate the gestures into intended input of the user into a typing system. Some embodiments of the system can include an auto-correct system, which can correct input from imprecise user movements. Examples of these auto-correction features are disclosed in U.S. patent application Ser. No. 13/747,700 which is hereby incorporated by reference in its entirety. In certain embodiments of the inventive system, an output of the typed text can be displayed on a computer monitor, or emitted as audio signals such as text to voice conversion to confirm to the user the text entered.

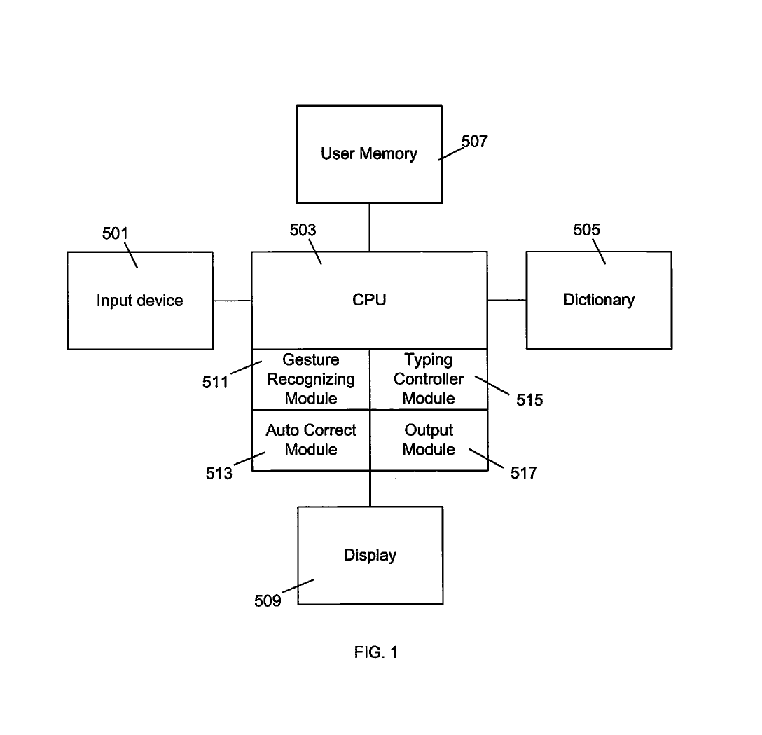

With reference to FIG. 1, a block diagram is illustrated showing a CPU 503 coupled to an input device 501, a dictionary database 505, a user memory 507 and a display output 509. Information is inputted through the input device 501. The CPU 503 receives the data from the input device 501 and calculates the locations of the input points, which may be the touch points and their sequence for an intended word. The CPU 503 processes the touch points and determines a sequence of X and Y coordinates associated with the input touch points. The CPU 503 may then perform additional processing to determine the intended word. The CPU 503 can run the modules: gesture recognizing module, Typing controller module, Autocorrect module and Output module.

The gesture recognition module of the inventive system will read the body movements of the user, and recognize a plurality of these movements as intended gestures of the user, performed in order to control the system.

In some embodiments of the system, the gesture-recognizing module will recognize taps in 3-dimensional space as the intention of the user to enter a letter onto the typing system. Using a 3-dimensional input sensor, the system can detect and track the user's hands, arms, and/or one or more fingers in a 3-dimensional space. Different embodiments of the system can track different body parts.

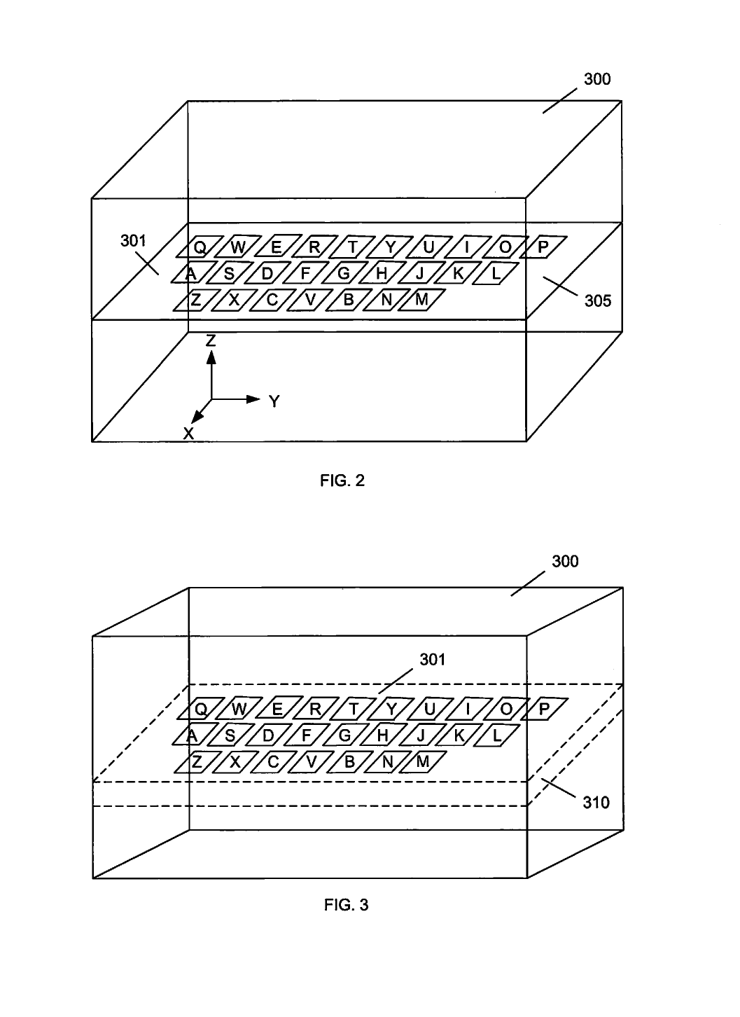

With reference to FIG. 2, in addition to detecting and tracking body part detection, the inventive system can also create virtual sensor areas within a 3-dimensional space 300. For example, in some embodiments, the gesture recognizing module can define a virtual plane in 3-dimensional space 300, defined by at least 3 known points in space 300. This virtual plane can define an area in space for a virtual keyboard 301 or any other virtual controller such as a virtual touch pad or a virtual mouse. If the inventive system uses a virtual keyboard 301 in 3-dimensional space 300, the system can track the user's body movement and compare the user's body movements against this virtual keyboard plane used as likely gestures for the action of pressing a button (“tap gestures”). FIG. 1 shows a diagram of virtual keyboard 301 in a 3-dimensional space 300 quantified by a X/Y/Z coordinate system. In this example, the virtual keyboard 301 can be on a defined plane 305 at z=10.

The plane 305 might be defined as a rectangular space, or may instead be a region on which gestures can be detected. This approach may provide for a more natural typing experience, allowing the user to approximate their body movements in a more natural way. In these embodiments, a tap will be registered as the point of intersection of the region with the finger. For example, FIG. 3 shows a detection region 310 rather than plane where the region is defined within the X/Y/Z coordinate system as z=8 at a front portion of the space 300 and z=12 at a back end of the space 300. Detection of the tap could be defined as an intersection of the whole region 310 (from z=8 to z=12) or a definition of a “large part” of such a region 310.

In contrast to other text input methods, the invention allows the user to type anywhere within a defined three dimensional open space 300, using a virtual keyboard 301 in space having a familiar keyboard layout like a QWERTY keyboard. The system is tolerant to text input transformations as well as imprecise input in general. Text input transformations can include: scaling, rotation, translation, warping, distortion, splitting, asymmetric stretching, etc. The user does not need to explicitly predefine/set the on-screen keyboard transformation, as this may automatically be deduced in real time and dynamically updated while typing. As a result, users can type with an arbitrary keyboard in their minds by placing a finger(s) in the three dimensional open space without the traditional need to look at a keyboard layout. In an embodiment, a user familiar with the system could type in three dimensional open space 300 without an actual on-screen keyboard at all, using a virtual keyboard 301 transformation of their choice.

In addition to being a stand alone or integrated into an operating system, the inventive system may also be compatible with other types of text input and auto correction systems. For example, some text based input systems use prediction algorithms which attempt to predict what words or phrases the user would like to type. These systems may overlay possible text predictions based upon the first few letters that have been typed. Because these predictions can be based upon a substantial match of the first letters, if there is an error, these systems will not function properly. In contrast, the inventive system is based upon the geometric shape of words which is a completely different input interpretation. Thus, in addition to existing text prediction, the inventive system can be used in combination with the known text prediction systems to produce even higher text interpretation accuracy. These auto correction systems can be layered on top of each other and the inventive word shape analysis can be one of these layers. In implementation, the system can display the possible candidate words or phrases.

The inventive system can be used with any type of keypad layout including QWERTY, Dvorak, Colemak, foreign language keyboards, numeric keypads, split ergonomic keyboards, etc. The inventive system is auto adaptive meaning that it will automatically adapt to the typing style and letter positions defined by the user and the word recognition will improve with use. The system can also adapt to the user by learning the user's typing style. For example, if a user types in a manner that is larger or smaller than a standard keyboard, the system will learn based upon the user's corrections the proper scale and position of the user's key position preferences. A user may type the word “FIND” but want to type the word “FINE”. The user can inform the system of the intended word was “FINE” and the system will learn that the user types the letter “E” at a lower position than expected. An adjustment can be made and the system may expect the shape of words that include the letter E and are inputted by the user to have the position of the E at a lower position relative to the other letters in the future and adjust the stored dictionary word shapes for words that have the letter E accordingly. Various other additional changes in typing style can be made by the user and the system may automatically adapt to accurately interpret the word shapes.

In embodiments of the inventive system, alternative gestures other than the letter inputs described above can be recognized by the system in order to control other functions of the keyboard. These other functions can include: actuating a space bar, invoking the auto-correct, entering a punctuation symbol, alternating between different word suggestions of the autocorrect module and other possible functions.

The gesture recognizing module may define other control gestures, where a body part will move in a direction not conflicting with or confusingly similar to the defined tap gestures (e.g. on a perpendicular axis to the defined typing plane). These other control gestures can be any gesture and can include various hand movements such as: waves, swipes, hand positions, etc. A wave can be interpreted as a hand movement in any direction that exceeds a predetermined distance and a predetermined speed. For example, the distance of the movement may need to be greater than about 1 foot and the velocity may need to exceed about 1 foot per second. In an embodiment, the detected instructions to the controller can be based upon the direction of a gesture such as a swipe, or the type of detected gesture such as a wave, either of which may control the function performed by the system.

In certain embodiments of the system, the wave gesture may be performed with any portion of an arm, hand and/or finger. The wave gesture may be performed by a different body part than the body part used to perform tap gestures, so as to better disambiguate between the two types of gesture. For example, in one embodiment of the inventive system, tap gestures will be defined based on movements of the fingers of the user, while wave gestures may be defined as movements of different portions of the limb, such as the whole hand in a direction. These wave gestures can be used to perform various different functions. For example, a wave to the right in the movement detection space can be used to input a space after text. A wave to the left in the movement detection space can be used to backspace and erase the last input text. Waving or up or down can be used to change the word suggestions suggested by the system.

In other embodiments, the system can be configured to match any detectable gesture to any typographical control function. For example, a thumbs up gesture in the detection space can be used to confirm an indicated word suggested or proposed by the system. A firm finger point forward can be used to input a period, or other symbol. A wave up or down can be used to change a punctuation mark. In some embodiments, a gesture can be used as a method to invoke a manual entry mode. For example, where waves in 1 direction can initiate a punctuation mark change, a circular hand motion can cause the system to scroll between possible punctuation marks or symbols and a thumbs up gesture can be used to confirm the punctuation marks or symbols.

In an embodiment, the system can track and index the user's finger tips and a space can be input with a thumb tap gesture in the motion detection space. The space thumb tap gesture can also be used to actuate an autocorrect mechanism. A left direction wave with an index finger in the detection space can cause a backspace.

The inventive system has described the input of letters through taps on a virtual keyboard in a three dimensional space. However, in other embodiments of the inventive system, various other types of motions, other than taps, can be detected by an input mechanism to indicate an intended input letter. For example in an embodiment, a gesture recognizer will track the trajectory of a moving body part such that a sudden change in movement direction could be detected. The gesture recognizer input device will therefore record the coordinates where the direction of the body movement changed as the likely coordinates of an intended tap gesture of the user in a virtual keyboard in a three dimensional space.

One possible example of an approach for detecting a sudden change of movement direction is for the inventive system to track the movement of a body part in the three dimensional space as a vector. The system can monitor and record the angle and velocity of the movement in the three dimensional space. A quick change in movement of the body part to an angle and/or velocity opposite to the initial trajectory, could indicate a tap has been effected, allowing the system to register the x, y, z coordinates where this tap was effected.

In these embodiments, the inventive system may be able to infer the orientation of a virtual keyboard in a three dimensional space from the user's tap or other gestures, without having a specific pre-defined plane or region for the virtual keyboard. The inventive system will collect all the x, y, z coordinates of the taps or other gestures, and use a technique such as multiple linear regression with the least squares method to deduce a typing plane of a virtual keyboard.

In other embodiments, the inventive system can filter out certain motions that can intersect the plane of the virtual keyboard in the three dimensional space. For example, in typical embodiments of the system, tap gestures will be defined as a movement of the body part in angles close to perpendicular to the virtual keyboard. Embodiments of the inventive system may configure the gesture recognizer to ignore the above defined tap gestures under certain conditions. For example, when the direction of movement of the body part is more than a certain number of degrees away from a perpendicular movement against a virtual keyboard in the three dimensional space, the system may interpret this motion as a non-intentional movement and will not interpret this motion as a keystroke input. In another embodiment, the system may require a straight movement trajectory through the virtual keyboard. If the detected movement is in a curved path, the system may also interpret this motion as a non-intentional movement and will not interpret this motion as a keystroke input.

Other embodiments may combine the above approaches. For example, some embodiments may define a region where taps can be accepted, and register tap events when a body part changes direction within this region. These embodiments may have the benefit of filtering out accidental body movements which were not intended by the user as inputs to the typing system, while still allowing some flexibility with inaccurate gestures. An extension of this approach may be to record both the direction, as well as velocity and acceleration of the body movement. Sudden changes in velocity (or a reversal of velocity), or acceleration, or a combination of these approaches can be used to effectively register tap events on the system.

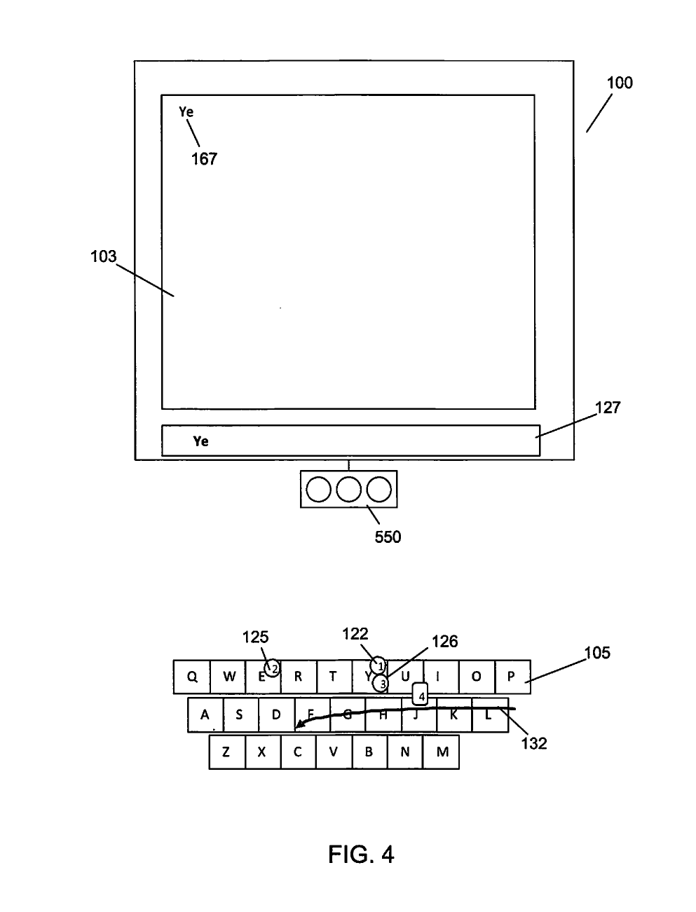

In an embodiment, the present invention allows the user to actuate a backspace delete function through an input gesture in the sensor detection space, rather than tapping a virtual “backspace” key. While the user is typing a word on a virtual keyboard 105 in a detected three dimensional space detected by a sensor 550, he or she may tap and input an incorrect letter. The user can notice this error and use a gesture in the sensor detection space which can be detected by the system and cause the system to remove the letter or effect of the last tap of the user, much as in the effects of a “backspace” button on hardware keyboards. After the deletion, the system will return to the system state as it was before the last tap of the user. In the embodiment shown in FIG. 4, the user has tapped on points (1) 122, (2) 125 and (3) 126 which respectively input “Y”, “e” and “y” before performing a left swipe 132 as designated by line 4. The left swipe 132 in the detected three dimensional space can erase the last tapped point (3) 126 resulting in the input text “Ye” 167 in the display and “Ye” in the possible word area 127 of an electronic device 100.

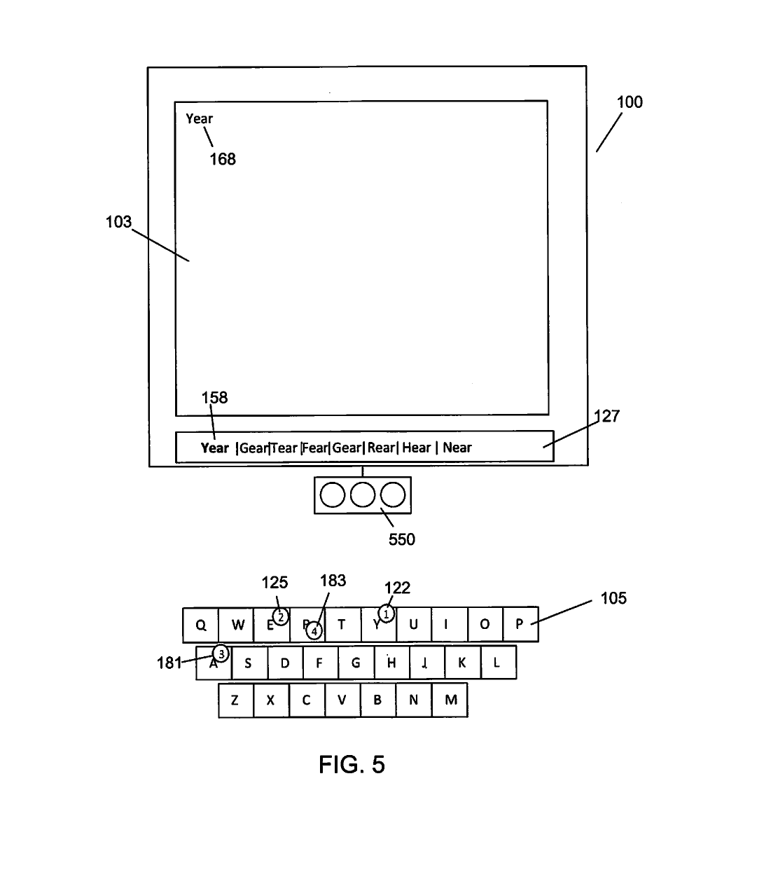

After making the correction described above with reference to FIG. 4, the user may then tap on points (3) 181 and (4) 184 in the sensor detection space corresponding to the letters “a” and “r” as shown in FIG. 5. The output of the program is similar to that expected if the user had instead tapped on points 1, followed by 3 and 4 in the sensor detection space corresponding to letters “a” and “r” and resulting in the text “Year”168 in the display 103 and Year 158 highlighted in bold in the possible word area 127 of an electronic device 100.

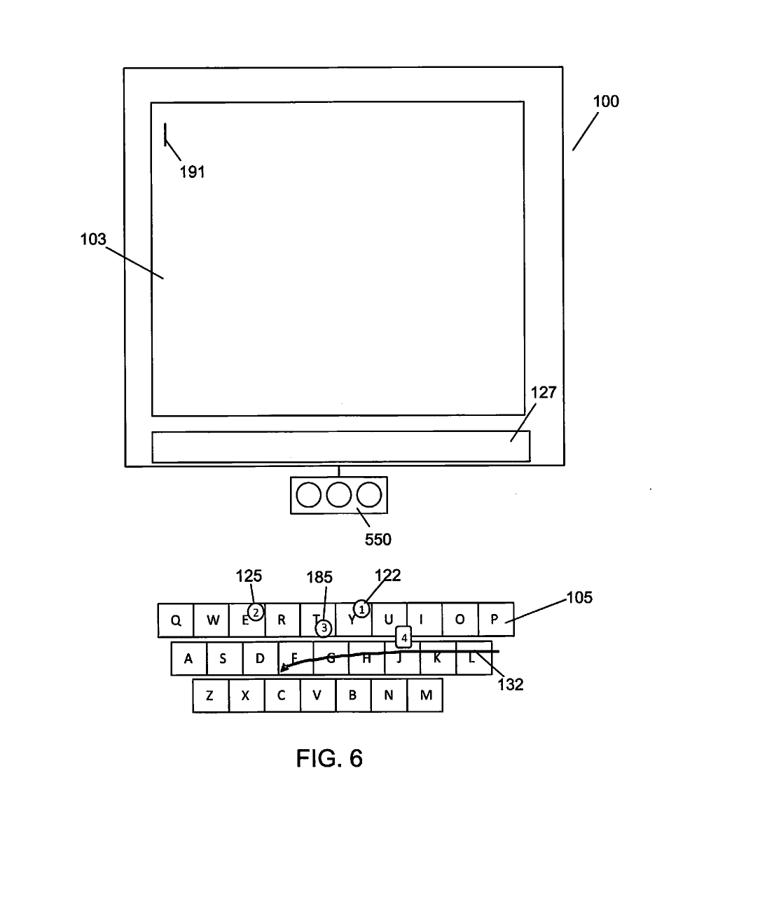

Certain embodiments of the system may enable methods to delete text in a faster way. The effect of the left swipe gesture 132 in the sensor detection space could be adjusted to delete words rather than characters. FIG. 6 shows an example of such a word erase system. The user has tapped on points (1) 122, (2) 125 and (3) 185 corresponding to the letters Y, E and T respectively. The system may recognize the full word “yet.” The user may then performed a left swipe gesture (4) 132, which is recognized by the system and causes the system to cancel all the taps and revert to the state it was in after the user's last swipe gesture. In this example, after the word delete, the text “yet” has been removed from the screen 103 and the possible word area 127.

In certain embodiments, the inventive system can be used to perform both letter and full word deletion functions as described in FIGS. 4 and 6. In order to distinguish the deletion of a letter or a word, the system may only perform the letter delete function in FIG. 4 when the user has performed a left swipe while in the middle of tapping letters of a word in the sensor detection space. When the word is not complete and/or not recognized as a full word by the system, each left swipe may have the effect of removing a single text character. However, when the swipe is performed after a complete word has been inputted, the system can delete the whole of that preceding word as shown in FIG. 6. In an embodiment, the system may display a text cursor 191 which can be a vertical line or any other visible object or symbol on the display 103. During the text input, the cursor can visually indicate the location of each letter input. Once a full word has been inputted, the cursor 191 can place a space after the word either automatically or by a manual gesture such as a word confirmation right swipe described above. As described above, the system can then determine if the letter back space or full word delete function should be applied.

In some embodiments, the system may enable a “continuous delete” function. The user may invoke this by performing a combination gesture of a left swipe and a hold gesture at the end of the left swipe in the sensor detection space. The function will have the effect of the left swipe, performed repeatedly while the user continues holding his finger on the screen at the end of the left swipe (i.e. while the swipe and hold gesture is continuing). The repetition of deletions could vary with the duration of the gesture; for instance, deletions could happen faster the longer the user has been continuing the gesture. For example, if the delete command is a letter delete backspace, the deletion may start with single character by character deletions and then starting to delete whole words after a predetermined number of full words have been deleted, for example one to five words. If the delete function is a word delete, the initial words may be deleted with a predetermine period of time between each word deletion. However, as more words are deleted, the system can increase the speed with which the words are deleted.

The above examples show the effects of up or down swipes in the sensor detection space to navigate and/or scroll between words in a list of system generated suggestions/corrections through the user input. This list can also include the exact text input by the user. In other embodiments of the system, additional gestures can be used which enable faster navigation between these suggestions. This feature can be particularly useful where there are many items to choose from.

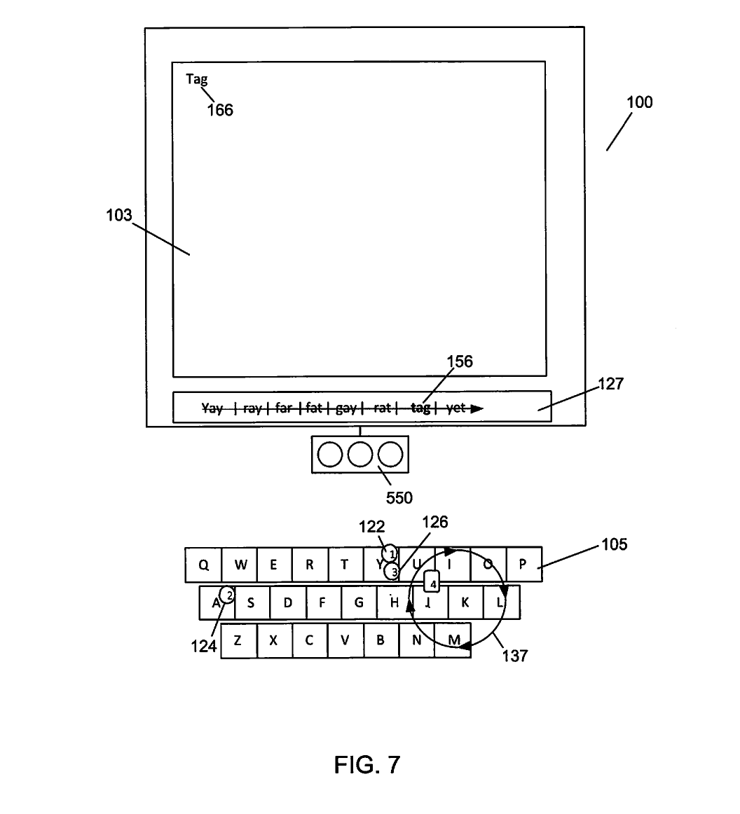

In an embodiment, the user can emulate a circular swipe motion in the sensor detection space which can be clockwise or anti-clockwise. For example as illustrated in FIG. 7, a clockwise circular motion 137 designed by circle 4 in the three dimensional space can have the effect of repeating the effects of one or more upward swipes and result in a forward scrolling through the listing of suggested words in the possible word area 127. In this example, the user may have tapped the word “Yay” and then made a clockwise circular motion 137 which caused the highlighted word in the possible word area 137 to scroll right. The user has stopped the clockwise circular motion 137 when the word “tag” 156 was in highlighted in bold. The system will simultaneously add the word “Tag” 166 to the display 103. In order to improve the efficiency of the word scrolling, the system may move to each sequential word in the possible word area 127 based upon a partial rotation.

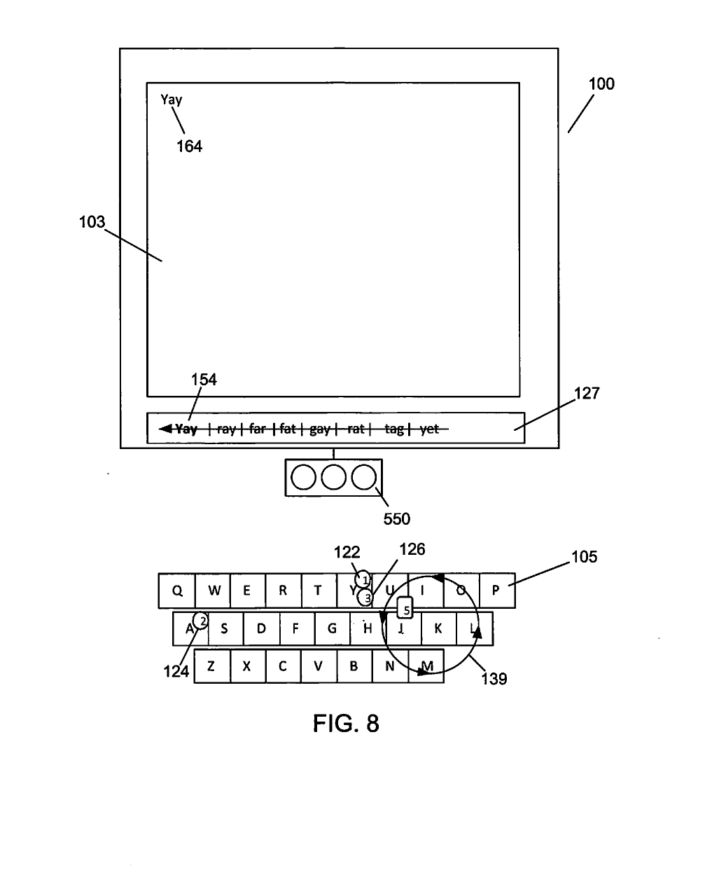

As illustrated in FIG. 8, a counter-clockwise motion 139 designed by circle 5 in the detected three dimensional space can have the effect of repeating the effects of one or more downward swipes and result in a backward scrolling through the listing of suggested words in the possible word area 127. The speed of the repetition or cycling to the left through the words in the listing of suggested words could be proportionate to the speed of cycling. In this example, the user has stopped at the word “Yay” 154 in the possible word area 127 and the word “Yay” 164 is in the display 103.

The system may sequentially highlight words based upon uniform rotational increments. The rate of movement between words could be calculated based on angular velocity. Thus, to reduce the rotational speed and increase accuracy the user can trace a bigger circle or vice-versa “on the fly.” If the speed of switching selected words is based on linear velocity, then the user could get the opposite effect, where a bigger circle is less accurate but faster. Like most gestures of the system, the circular motion can begin at any point in the sensor detection space. Therefore high precision is not required from the user, while still allowing for fine control. For example, the system may switch to the next word after detecting a rotation of ⅛ rotation, 45° or more of a full circular 360° rotation. The system may identify rotational gestures by detecting an arc swipe having a radius of about 2 to 20 inches. These same rotational gestures can be used for other tasks, such as moving the cursor back and forth within the text editing area.

In embodiments of the system, the gesture recognizer will translate recognized gestures of the user into intended input, and thus control a typing controlling module which will input the intended characters on a computer system. The typing controller will receive the signals from the motion detection input device and recognize the input of text, as well as space characters, backspace effectuations, and may connect with an auto-correct system to help the user correct typing mistakes.

In other embodiments, the typing controller may provide additional functionality, such as to format the appearance of the text, or the document layout. This functionality may be invoked with additional gestures using the 3-D sensor, or may use other input controllers to a computer system such as a keyboard, mouse, or touch-screen.

In some embodiments of the invention, the text input system described may be available in parallel with other typing systems using other input controllers, such as a touch-screen or a keyboard. In these embodiments it is likely that these input controllers may aid the user when input of extended amounts of text, or specially formatted text may be required.

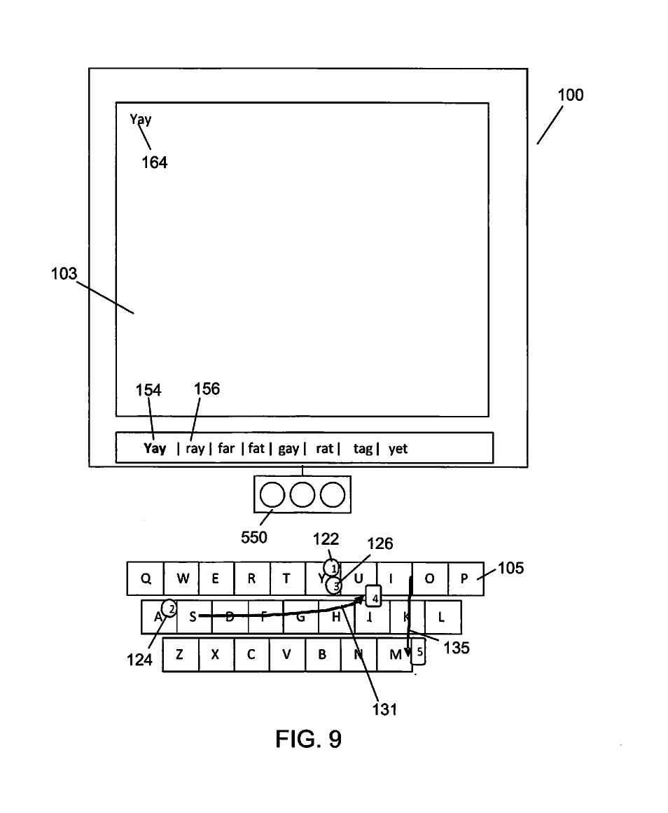

In an embodiment, the inventive system may also allow the user to manually enter custom text, which may not be recognized by the system. This can be illustrated in FIG. 9. The user, in this example, has tapped the word “yay.” In the illustrated example, the user has inputted a first tap on “a” 122, a second tap on “a” 124 and a third tap on “y” 126 in the sensor detection space. Upon the user's selection of a right swipe 131 in the sensor detection space designed by line 4 which may initiate the correction mode, the system will auto-correct the input to the word “ray” 156, the next sequential word in the possible word area 127 which may be the closes match found by the system dictionary algorithm. The user could then use a single downward swipe 135 in the sensor detection space designated by line 5 to revert to the originally input text “yay” 164 on the display 103 and “yay” 154 listed in the possible word area 127. In an embodiment, the right swipe 131 and then the down swipe 135 could be applied in one continuous multi-direction swipe in the sensor detection space commencing in a right direction and then changing to a down-bound direction. In certain embodiments of the system, it may be possible to initiate a special state of the system in which the auto correct functionality is easily enabled and disabled allowing the user to type without the system applying any corrections with any confirmation swipes.

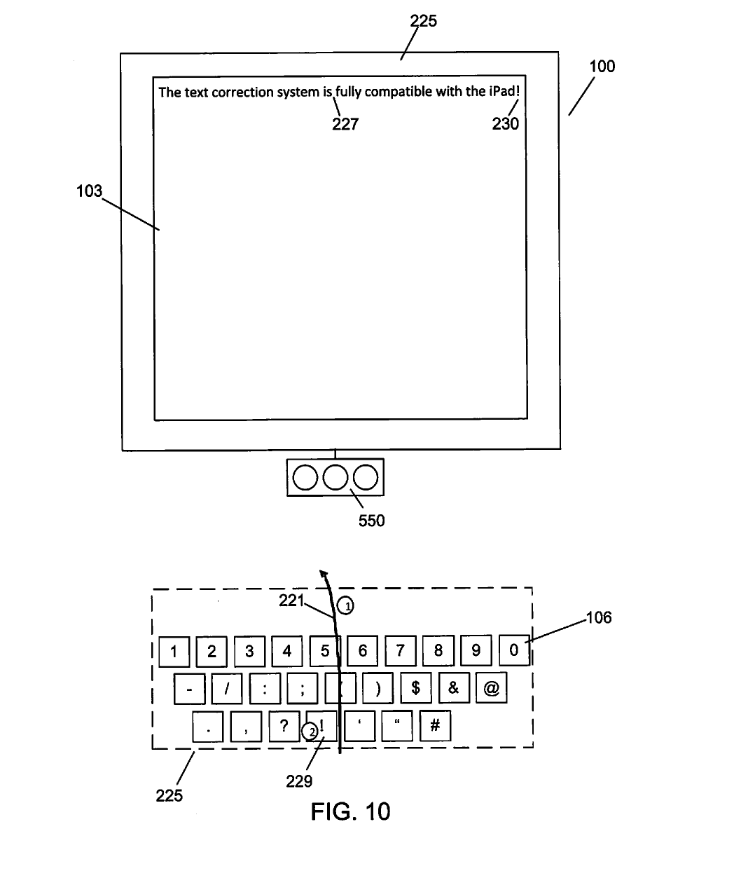

The present invention may include systems and methods for inputting symbols including: punctuation marks, mathematical, emoticons, etc. In certain embodiments of the invention, the users will be able to change the layout of the virtual keyboard in the sensor detection space which is used as the basis against which different taps are mapped to specific letters, punctuation marks and symbols. With reference to FIG. 10, in an embodiment, a symbol or any other virtual keyboard 106 can be displayed after the user performs an up-bound swipe gesture (1) 221 commencing at or near some edge of the sensor detection space rather than in the main portion in the sensor detection space over any of the virtual letter keys. In order to simplify the lower edge area, the system may have a predefined edge region 225 around the entire sensor detection space. When the system detects a swipe commencing in the predefined edge region 225, the system can replace the virtual letter keyboard map with a different one, such as a number keyboard 106 shown. Subsequent keyboard change gestures 221 may result in additional alternative keyboards being displayed such as symbols, etc. Thus, the system can distinguish edge swipes 221, that start from the predefined edge region 225, from normal swipes, that are commenced over the virtual keyboard 106 or main display area 103 of the detected three dimensional space. As discussed above, motion detection space may have an outer region 225 that can be a predetermined area or volume that surrounds the perimeter in the sensor detection space. By detecting swipes that originate in the outer region 225, the system can distinguish edge swipes from center display 103 swipes.

In some embodiments, this up-bound gesture may invoke different virtual keyboards in a repeating rotation. For example, the system may include three virtual keyboards which are changed as described above. The “normal” letter character virtual keyboard may be the default virtual keyboard. The normal virtual keyboard can be changed to a numeric virtual keyboard, which may in turn be changed to a symbol virtual keyboard. The system may include any number of additional virtual keyboards. After the last keyboard is displayed, the keyboard change swipe may cause the keyboard to be changed back to the first normal letter character keyboard. The keyboard switching cycle can be repeated as necessary. In an embodiment, the user can configure the system to include any type of keyboards. For example, there are many keyboards for different typing languages. Because the letters, numbers or symbols may not be displayed in the sensor detection space, the display may indicate the keyboard being used. For example for a QWERTY keyboard, the system may display the text “QWERTY.” The system can display a similar indicator for a symbol or a foreign language keyboard.

In other embodiments, the location of the swipe may control the way that the keyboard is changed by the system. For example, a swipe from the left may invoke symbol and number keyboards while a swipe from the right may invoke the different language keyboards. In yet another embodiment, the speed of the keyboard change swipe may control the type of keyboard displayed by the system.

Once the keyboard has been changed to a non-letter configuration, the taps of the user will be interpreted against the new keyboard layout reference. In the example of FIG. 10, the user has tapped the desired text, “The text correction system is fully compatible with the iPad” 227. The user then inputs a swipe up 221 gesture from the bottom of the sensor detection space in the predefined edge region around the main sensor detection space. This detected gesture can be indicated by Line 1. The system can interpret this gesture as a command to change the virtual keyboard from a letter keyboard to a number and symbols keyboard 106. Once the number and symbols keyboard 106 is displayed, the user taps on the “!” 229 designated by reference number 2 to add the exclamation mark, “!” 230, at the end of the text sentence. The output reflects the effect of the swipe 221 to change the keyboard to number and symbols keyboard 106.

The system can automatically correct the capitalization and hyphenation of certain common words. Thus, when a user types a word such as, “atlanta” the system can recognize that this word should be capitalized and automatically correct the output to “Atlanta.” Similarly, the input “xray” could automatically be corrected to “x-ray” and “isnt” can be corrected to “isn't.” The system can also automatically correct capitalization at the beginning of a sentence.

Additionally, the present invention allows for the user to manually add or remove capitalization as a word is typed. In an embodiment, the command to input manual capitalization control can be actuated when the system detects a user performing an upwards swipe gesture in the sensor detection space. This upward swipe can change lower case letters to upper case letters, or alternatively a user performing downward swipe gestures can be interpreted by the system as a command to change upper case letters to lower case letters. These upward and downward swipe gestures are inputted as the user is typing a word, changing the case of the last typed character.

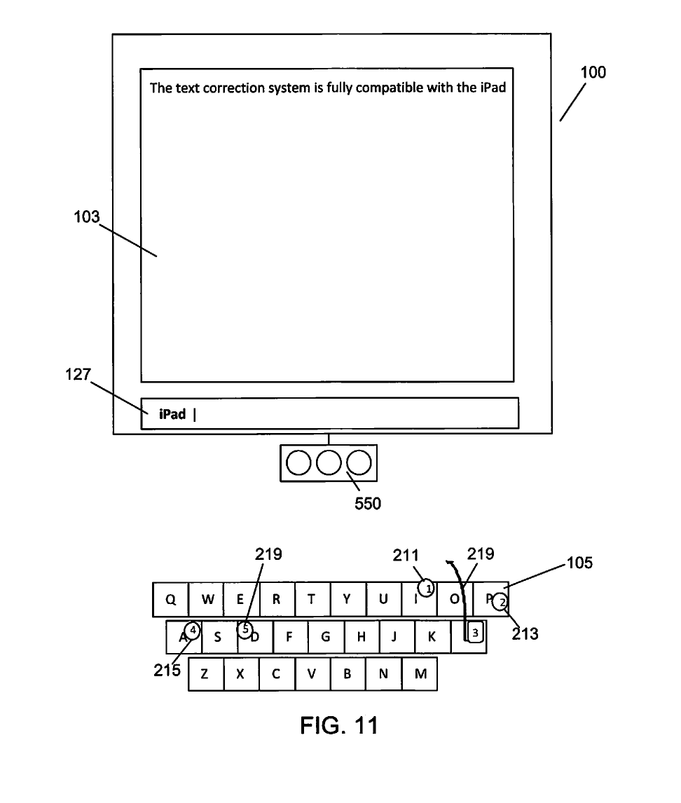

FIG. 11 shows an example of the capitalization function. If the user wants to type the word iPad, he would tap on the relevant points (1) 211 for the letter “i” and (2) 213 for the letter “p.” In order to capitalize the letter “P”, an upwards wave gesture (3) 219 is performed after the second tap at (2) 213 in the sensor detection space. The upward swipe gesture can be from any point on the text input keyboard plane. This would have the effect of capitalizing the immediately preceding letter, in a way that resembles the effect of pressing the “shift” button on a hardware keyboard changing the lower case “p” to an upper case “P” in both the display 103 and the possible word area 127. The user can then continue to tap on points (4) 215 for the letter “a”, and (5) 217 for the letter “d” to complete the word, “iPad.”

In an embodiment, the inventive text input system may have a “caps lock” function that is actuated by a gesture and would result in all input letters being capitalized. The “caps lock” function could be invoked with an upwards wave and hold gesture in the sensor detection space. The effect of this gesture when performed between taps would be to change the output to remain in capital letters for the preceding and all subsequent taps of the current word being typed and all subsequent letters, until the “caps lock” function is deactivated. In an embodiment, the “caps lock” function can be deactivated with a downwards swipe or a downward swipe and hold gesture in the sensor detection space.

In another embodiment, a different implementation of the capitalization function could emulate the behavior of a hardware “caps lock” button for all cases. In these embodiments, the effect of the upwards swipe performed in between taps would be to change the output to be permanently capital until a downwards swipe is performed in the sensor detection space. The inventive system may be able to combine the capitalization function with the auto-correct function, so that the user may not have to type exactly within each of the letters, with the system able to correct slight position errors.

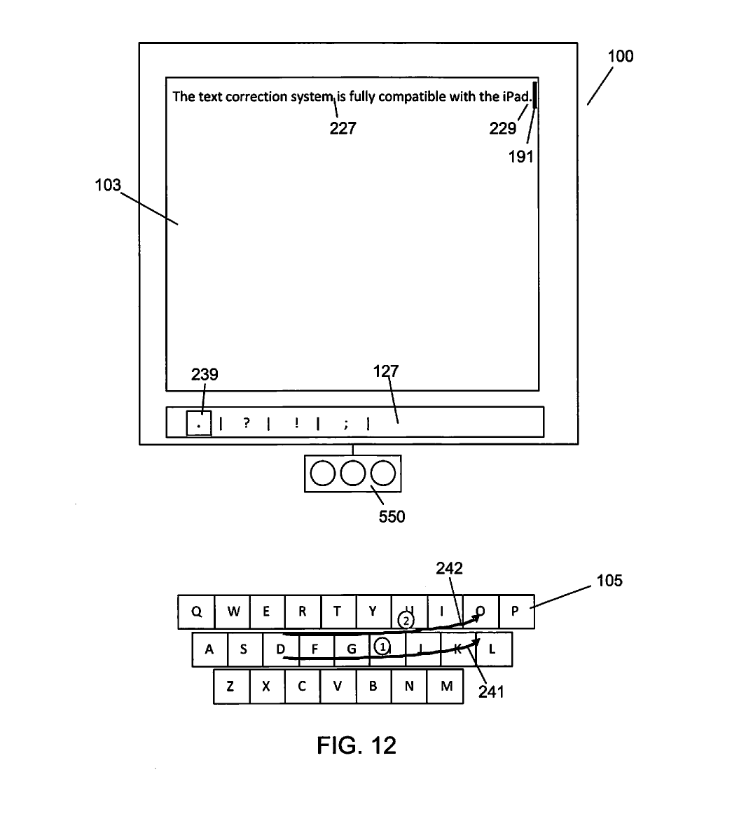

In embodiments of the invention, the system may include shorter and more efficient ways to enter some of the more common punctuation marks or other commonly used symbols. These additional input methods may also allow for imprecise input. With reference to FIG. 12, the punctuation procedure can commence when the system is in a state where the user has just input text 227 and input a first right swipe 241 designated by line 1 in the sensor detection space to indicate a complete word and space. If the user then performs a second right swipe 242 designated by line 2 before tapping the keyboard plane in the sensor detection space for additional text in the next sentence, the system will insert a period 229 punctuation mark after the text 227. At this point, the period 329 is also displayed in the possible area 127 with other punctuation marks which may be offered as alternative suggestions. The period “.” 239 is highlighted and the user may navigate through the other punctuation marks in the possible area 127 using the up/down swipe gestures described above. In this example, the suggested punctuation period “.” 239 is outlined. It may be difficult to clearly see the suggested or current punctuation mark bold text. Thus, another highlighting method can be outlining as illustrated around the period 239.

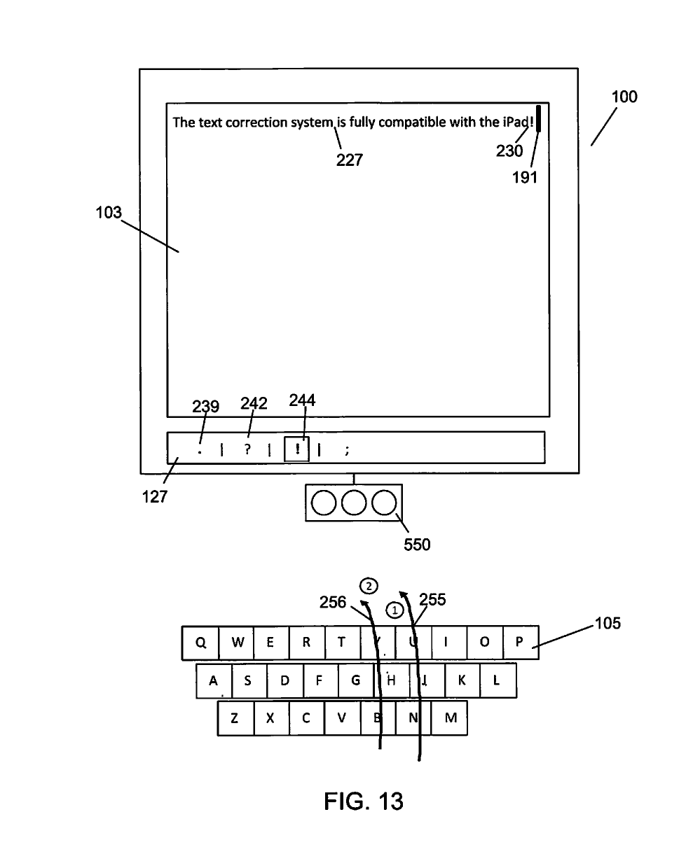

With reference to FIG. 13, if the user performs two sequential up swipe gestures 255, 256 designated by lines 1 and 2 in the sensor detection space, the system will replace the “.” with a exclamation “!” 230 punctuation mark. The system will first highlight the “?” 242 after the first up swipe 255 and then highlight the “!” 244 after the second up swipe 256. The “!” 230 will simultaneously be displayed after the text 227 in the display.

In other embodiments, the system can recognize certain gestures for quickly changing the layout of the keyboard without having to invoke any external settings menus or adding any special function keys. Any of the above describes gestures, including a swipe from the bottom of the sensor detection space, which may be used to invoke alternative number and symbol keyboards as described. Alternative functions can be implemented by performing swipes with two or more fingers. For example, a two fingers upwards swipe starting from the bottom half of the screen or within the virtual keyboard boundaries could invoke alternative layouts of the keyboard, such as alternative typing languages.

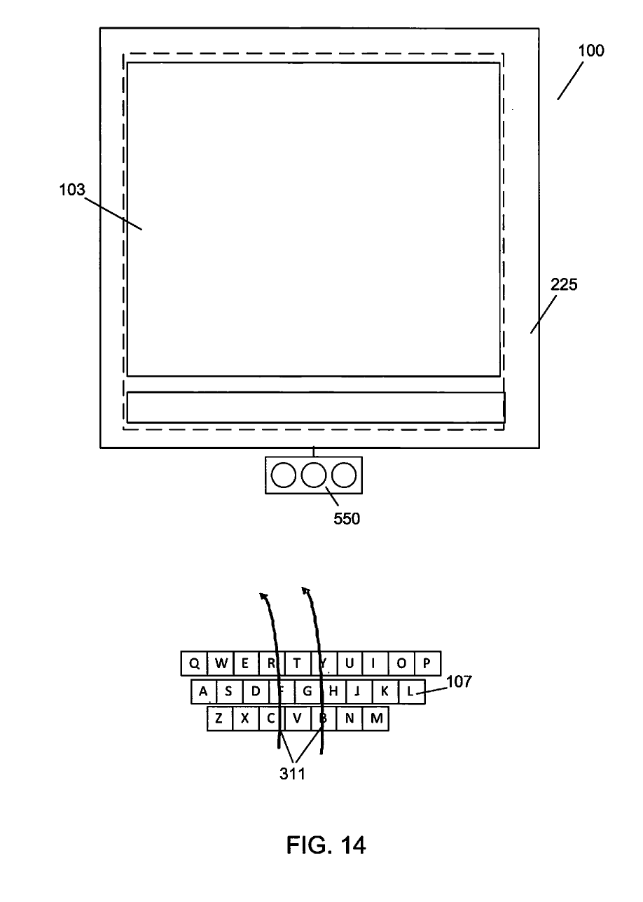

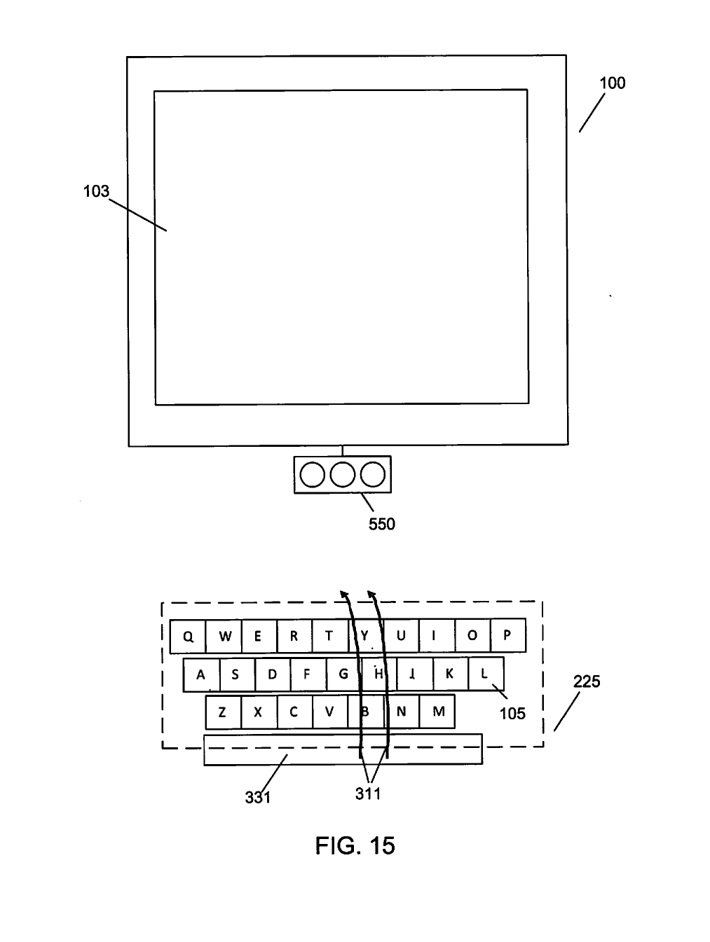

With reference to FIG. 14, in an embodiment, a swipe 311 performed with two fingers in an upwards trajectory starting from the top half of the sensor detection space could be used to resize the virtual keyboard 105 in the keyboard plane in the sensor detection space. In this example, the keyboard 107 is smaller as a result of the two finger swipe 311. In an embodiment, the size of the keyboard 107 can be controlled by the length of the swipe 311. A short up swipe can cause a slight reduction in the size of the keyboard 107 and a long swipe 311 can cause a much smaller size keyboard 107. Conversely, a two finger downward swipe can cause the keyboard to become enlarged. Alternatively, with reference to FIG. 15, a two finger swipe 311 in an upwards trajectory in the sensor detection space could show or hide some additional function keys. For example, the swipe 311 could add a space button 331 to a keyboard 105, which could be removed by the opposite, downwards two finger swipe. When the space button 331 is shown on the keyboard 105, the right bound swipe gesture may also be available for typing a space character as described above, or this feature may be automatically turned off. Again, it may be possible to distinguish two finger swipes based upon the location of the beginning or end of the swipe. In different embodiments, the system can distinguish swipes starting or ending in the boundary area 225 as well as the upper or lower halves of the screen 103.

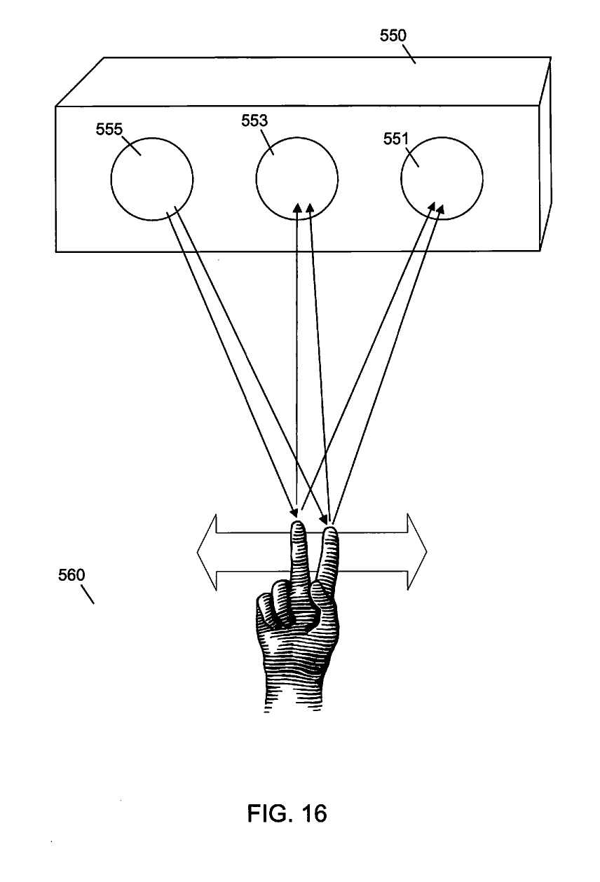

With reference to FIG. 16, in an embodiment, body movement or finger gestures of a user can be obtained using an optical device comprising an image camera 551, an infrared (IR) camera 553 and an infrared (IR) light source 555 coupled to a signal processor. The IR light source 555, IR camera 553 and an image camera 551 can all be mounted on one side of the optical device 550 so that the image camera 551 and IR camera 553 have substantially the same field of view and the IR light source 551 projects light within this same field of view. The IR light source 555, IR camera 553 and image camera 551 can be mounted at fixed and known distances from each other on the optical device 550. The image camera 551 can provide information for the patient's limb 560 or portion of the patient within the viewing region of the camera 551. The IR camera 553 and IR light source 555 can provide distance information for each area of the patient's limb or digits 560 exposed to the IR light source 555 that is within the viewing region of the IR camera 553. The infrared light source 555 can include an infrared laser diode and a diffuser. The laser diode can direct an infrared light beam at the diffuser causing a pseudo random speckle or structured light pattern to be projected onto the user's body 560. The diffuser can be a diffraction grating which can be a computer-generated hologram (CGH) with a specific periodic structure. The IR camera 553 sensor can be a CMOS detector with a band-pass filter centered at the IR laser wavelength. In an embodiment, the image camera 551 can also detect the IR light projected onto the user's limbs, hands or digits 560.

Errors are very common in any text input system. In particular, when the text input is through a virtual keyboard in a 3 dimensional space, it can be very easy to make erroneous body movements within the sensor detection space, causing motion sensor inaccuracies. In order to correct these errors, the inventive text input system can include an auto correction system. In an embodiment, the inventive system can identify an intended word based upon a plurality of input letters.

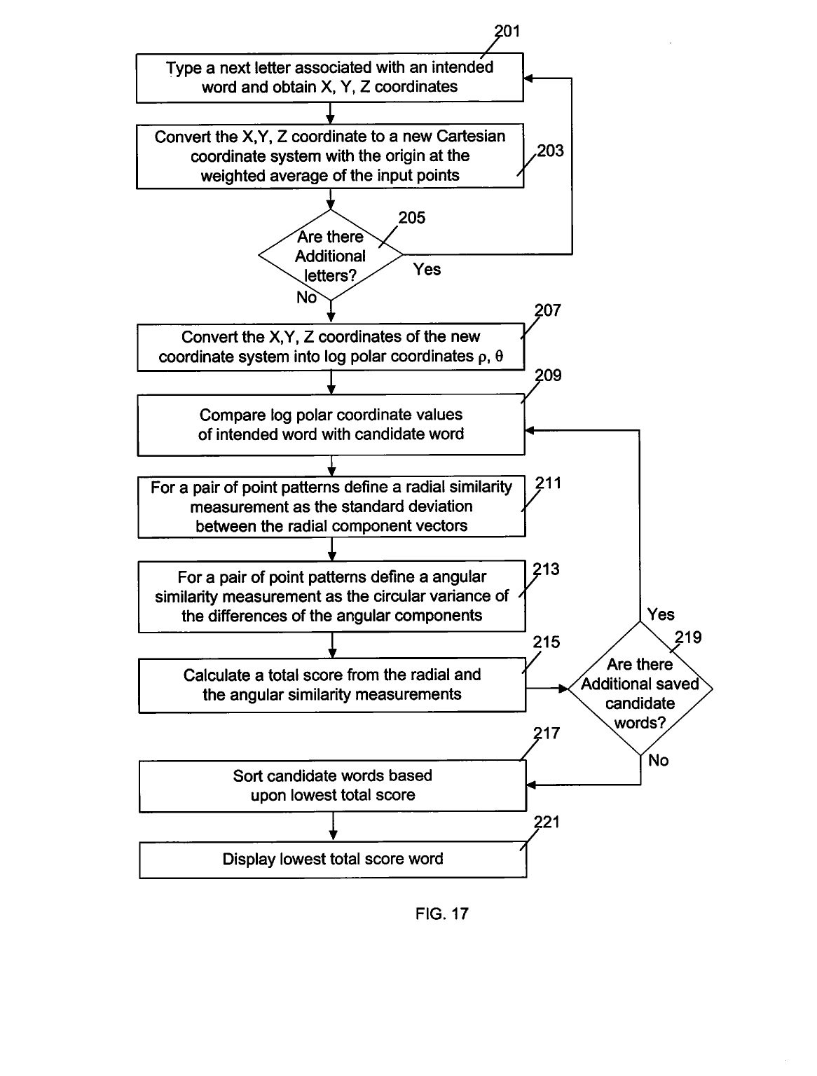

With reference to FIG. 17, a flow chart of an embodiment of processing steps for determining an intended word from a set of touch points inputs into a detected three dimensional space is illustrated. The system can detect a touch input for a letter of an intended word 201. The location of the touch can be detected as an X, Y, Z coordinate on the touch sensor. The system can then convert the X, Y, Z coordinates from the input into a new Cartesian coordinate system. In the new Cartesian coordinate system, the origin or 0, 0, 0 point is set to an anchor point such as a geometric median or some weighted average of the input points 203. The system will also detect additional letter inputs 205. If additional letters are inputted, the step 201 can be repeated and the origin point can be recalculated as more X, Y, Z coordinates are obtained for each additional letter. In other embodiments, the system may wait until a predetermined number of letters have been inputted before performing the conversion of the X, Y, Z coordinates to a new Cartesian coordinate system.

After some or all of the letters for the intended word have been inputted, the system can define a plane of a virtual keyboard. The system can then convert the X, Y, Z values into X, Y coordinates on the plane of the virtual keyboard. The X, Y virtual keyboard plane values can be converted to a new Cartesian coordinate system for the intended word into a log polar coordinate system with each point having a ρ, θ for a log polar coordinate system. In a log polar system the R value can be the distance between the origin and the input letter position and in a log polar system the ρ value can be the log of the distance between the origin and the input letter position. For log polar coordinate systems θ is the angular value of the input letter position relative to the origin. The equations for ρ and θ are listed below.

ρ=log\sqrt{X²+Y²} Θ=arctan(Y/X)

The ρ values for the intended word can be compared to the ρ values of a set of candidate words 209. A basic concept of this comparison is to compare the radial similarities of the input intended word to a set of candidate words stored in a memory or database. The radial distances of the letters can be the distances between the origin and each of the input points. The radial distances of the input word can be compared to the stored radial distances of candidate words. In some embodiments, weights can be applied to each of the radial values of the points. These values can be uniform, symmetric, asymmetric or any other suitable weigh system that can improve the matching of the inputs to the intended word.

In addition to the radial comparison, a rotational value similarity comparison can be performed for the intended word with the candidate words. The angular similarity analysis can be performed using a substantially different analysis than the radial value similarity comparison. In an embodiment, the θ values for each of the input points of the intended word input from the polar or log polar coordinate values can be compared to the θ values for each of the points of the candidate words 213. The differences between the detected and the angular values for the prospective words produce a Δθ value for each point. The Δθ values for all of the points in the word can be multiplied by a weight. As discussed above with regard to the radial weights, the weights can be uniform, variable symmetric, variable asymmetric or any other weight configuration. The basic idea is that if a rotated word has uniform Δθ values for each of the points, this can indicate that there is a match between the input intended word and the stored prospective word.

Once the radial and angular values are determined for a candidate word, the system can determine if there are additional candidate words 219. If there are additional candidate words, the process is repeated. Alternatively, if there are no additional candidate words, the system will sort all of the candidate words to determine the best matching candidate word based upon a lowest standard deviation of radial distances and the lowest variance of angular values 217. The system can present the best candidate word to the operating system and the operating system may display the best candidate word 221. The system can then be repeated for the next candidate word.

If an error has been made and the best candidate word that was displayed is not the intended word, the user can input the intended word and the system can analyze where the error was made. In many cases, the user may have a tendency to type certain points in an atypical manner that is offset from a normal QWERTY or other keyboard pattern. The system can make the necessary adjustments to correct this problem so that when the user types the same intended word, the correct prospective word will be selected by the system.

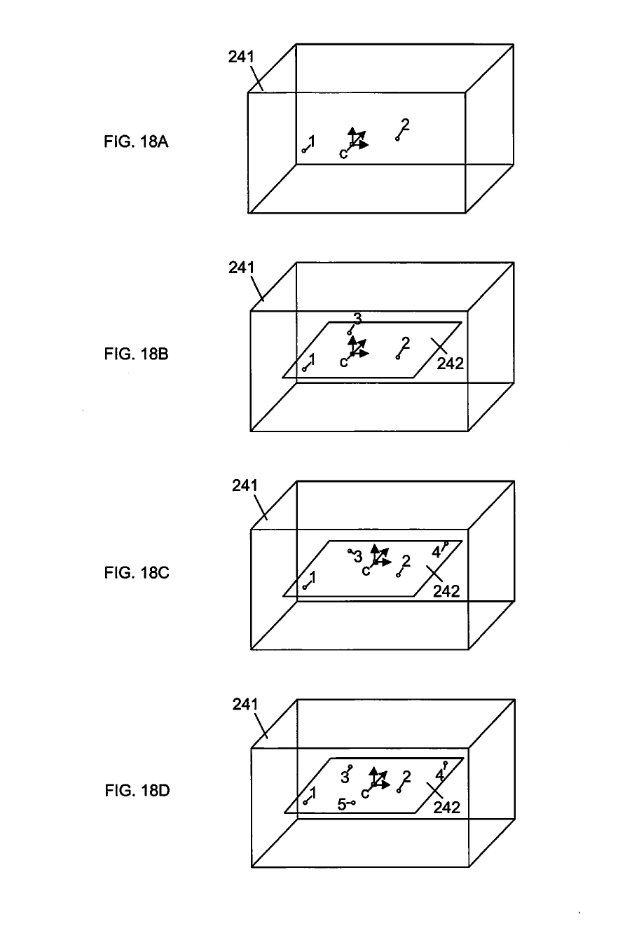

As discussed with reference to step 203 of FIG. 17 above, the X, Y, Z input locations for the intended word can be converted to a new Cartesian coordinate system. With reference to FIGS. 18A-18D, graphical representations of the anchor point “A” are illustrated. As the points for the intended word are sequentially inputted, the system can convert the X, Y coordinates of the detected touch points on an input device 241 to a new Cartesian coordinate system. The 0, 0, 0 origin point A of the new coordinate system can be set at the anchor point “A” of the input points 1, 2, 3, 4, 5 . . . . The anchor point location can be at the average or weighted average points of the input points. In FIG. 18A, the anchor point is between the first touch point 1 and the second touch point 2. In FIG. 18B, the first touch point 1, the second touch point 2 and the third touch point 3 define a plane 242. In FIGS. 18C-18D, as additional points are added, the location of the anchor point A changes. The anchor point A can be based upon equal weighting of all of the input points. When weighting is used, the anchor point location, C, will shift and the weighted anchor point location can be calculated based upon the following equations:

X_{anchor point}=Sum(X)(Wi)/((i)(SumWᵢ))

Y_{anchor point}=Sum(Y)(Wi)/((i)(SumWᵢ))

Z_{anchor point}=Sum(Z)(Wi)/((i)(SumWᵢ))

Where: Wi=weight for the sequential point i,
i=total number of points and
SUM (Wi)=cumulative weights for all total points.

In an embodiment, the inputs for each touch point can be X(i), Y(i), Z(i) and the anchor point value X_{anchor point} can be calculated by Sum X(i)/N, the value of Y_{anchor point} can be calculated by Sum Y(i)/N and the value of Z_{anchor point} can be calculated by Sum Z(i)/N. Because the X, Y and Z coordinates for each touch point are generally within the plane 242 of the virtual keyboard, the X, Y and Z coordinates can be converted into X and Y coordinates on the plane 242.

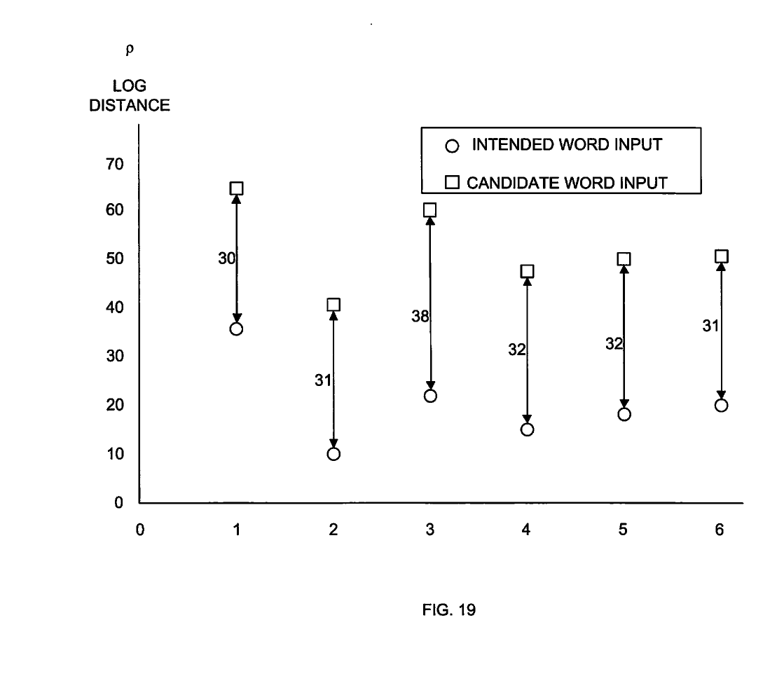

In an example comparison, an intended word can have six input points and can be compared to a similar six point candidate word. With reference to FIG. 19, the radial values for an intended word and a candidate word are graphically illustrated. With reference to Table 1, the input radial log distances of the input points are compared to the stored radial distances of a stored candidate word. A delta log distance is determined for each point. This comparison can detect the similarities in the radial distances, regardless of the scale. Thus, even if the radial distances for each point do not match, but the scaled radial distance values do match, the intended word will be considered to be a match with the candidate word.

TABLE 1

| POINT # | 1 (A) | 2 (T) | 3 (O) | 4 (M) | 5 (I) | 6 (C) |
|---|---|---|---|---|---|---|
| CANDIDATE | 64 | 41 | 60 | 47 | 50 | 51 |
| WORD LOG | | | | | | |
| DISTANCE ρ | | | | | | |
| INTENDED | 36 | 10 | 22 | 15 | 18 | 20 |
| WORD LOG | | | | | | |
| DISTANCE ρ | | | | | | |
| Δ LOG | 28 | 31 | 38 | 32 | 32 | 31 |
| DISTANCE ρ | | | | | | |

In the comparison analysis, the system can determine the similarities of the radial values and rotational values for the intended word and a set of candidate words. In some embodiments, weights can be applied to each of the radial values of the points. These values can be uniform, symmetric, asymmetric or any other suitable weigh system that can improve the matching of the inputs to the intended word. An average Δ log distance can be calculated to be 31.5 and a standard deviation can be calculated to be 0.7906. A low standard deviation indicates that the candidate word is very similar to the intended word, with a standard deviation of 0 indicating a perfect match. This process can be repeated for all candidate words and the standard deviation can be used to measure the similarity of the intended word to the candidate word. The scale factor between the intended and candidate words can be calculated to be e^{average Δ log distance}.

In other embodiments, weights for the radial distance values can be applied. The described anchor point calculation above can be an example of a uniform weight applied to each point. It is also possible to apply weights in a non-uniform manner. With reference to Table 2, the weights for the different input points are listed and applied resulting in a change in the Δ Weighted Log Distance ρ values. In this example, the weights are asymmetric increasing with each incremental point position. In other embodiments, any other suitable type of weighting can be used.

TABLE 2

| POINT # | 1 (A) | 2 (T) | 3 (O) | 4 (M) | 5 (I) | 6 (C) |
|---|---|---|---|---|---|---|
| Δ LOG | 28 | 31 | 38 | 32 | 32 | 31 |
| DISTANCE ρ | | | | | | |
| STANDARD | 16 | 1 | 36 | 0 | 0 | 1 |
| DEVIATION | | | | | | |
| WEIGHT | 0.4 | 0.8 | 1.6 | 2.8 | 4.0 | 5.6 |
| WEIGHTED | 6.4 | 0.8 | 57.6 | 0 | 0 | 5.6 |
| STANDARD | | | | | | |
| DEVIATION | | | | | | |
| OF Δ LOG | | | | | | |
| DISTANCE ρ | | | | | | |

In other embodiments, the anchor point can be based asymmetrically upon the input points. For example, the anchor point may only be based upon the locations of the first 3, 4, 5 . . . points rather than all points. Alternatively, the anchor point can be based upon the locations of the last 3, 4, 5 . . . points. The weighting should be applied uniformly to both the input intended word as well as all candidate words.

As discussed, the rotational value similarity comparison can be performed in a substantially different analysis than the radial value similarity comparison since a traditional standard deviation cannot be used on values that represent angles. Angular values are measurements that extend around a circle such as 360° and then repeat with higher angles. Because this is substantially different than linear distance measurements, a standard deviation of the angles cannot be applied. The θ values for each of the input points of the intended word input can also be compared to the θ values for each of the points of the candidate words 213, FIG. 17. The angular values from the anchor point for the input points of the intended word can be determined. These values can also be compared to the angular values for the prospective words and the Δθ can be determined for each point as shown in Table 3.

TABLE 3

| POINT # | 1 (A) | 2 (T) | 3 (O) | 4 (M) | 5 (I) | 6 (C) |
|---|---|---|---|---|---|---|
| CANDIDATE | 195 | 155 | 32 | 338 | 55 | 240 |
| WORD θ | | | | | | |
| INTENDED | 185 | 143 | 16 | 327 | 41 | 222 |
| WORD θ | | | | | | |
| Δ θ | 10 | 12 | 16 | 11 | 14 | 18 |

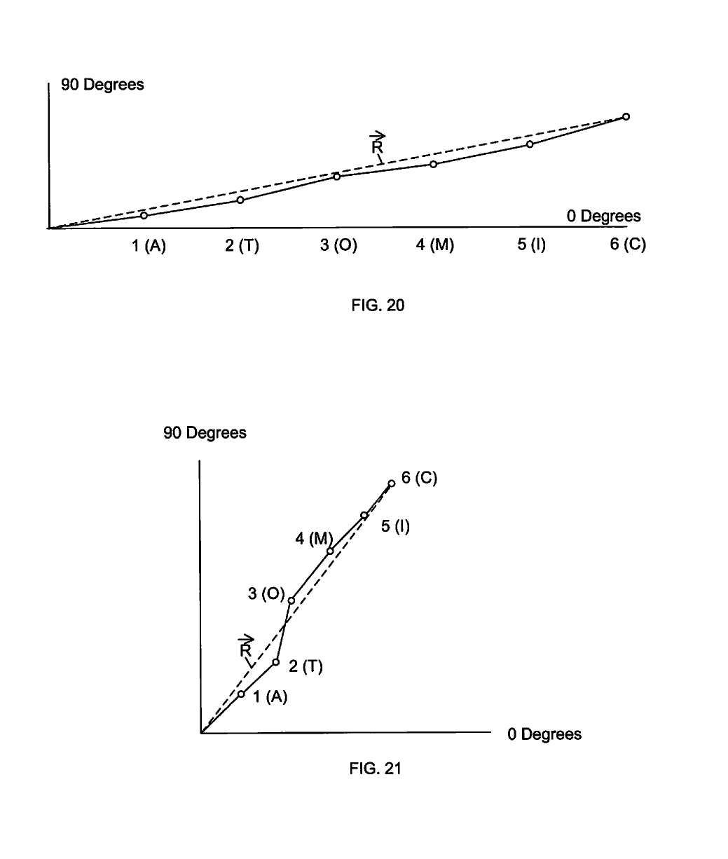

With reference to FIG. 20, the Δθ values can be plotted with respect to each letter. Because weights have not been applied or uniform weights have been applied, the distances between each of the inputs are the same. A line drawn between the origin and the end point 6 (C) represents a vector that has an angle that is the average shift angle between the input intended word and the prospective word. The angular similarity can be measured by observing the “straightness” (circular variance) of the Δθ vectors, which is a function of the sum of the lengths of those vectors and the length of the combined vector. The more similar those two values are, the more uniform the delta angle vectors are.

In other embodiments non-uniform weights can be applied to the angular values as shown in Table 4. The calculation of the circular variance can be performed as follows. The angles of the graphical segments are the Δθ for each sequential letter and the lengths of the segments are based upon the weights of the letters. In this example, a non-uniform weight is applied to each of the angular values. The weighted Δθ values can be plotted for each letter as shown in FIG. 21.

TABLE 4

| LETTER # | 1 (A) | 2 (T) | 3 (O) | 4 (M) | 5 (I) | 6 (C) |
|---|---|---|---|---|---|---|
| WEIGHT | 2.9 | 3.5 | 4.7 | 4.7 | 3.5 | 2.9 |
| CANDIDATE | 565.5 | 542.5 | 150.4 | 1588.6 | 192.5 | 696 |
| WORD θ | | | | | | |
| INTENDED | 536.5 | 500.5 | 75.2 | 1536.9 | 143.5 | 643.8 |
| WORD θ | | | | | | |
| Δ θ | 29 | 42 | 75.2 | 51.7 | 49 | 52.2 |

In another embodiment, the system can determine the angular similarities by other calculations. The system may initialize the statement machine based upon the following equations: sum Sin=0, sum Cos=0 and sum Weights=0. For each point, an angle weight pair will be provided and these polar values can be broken up in to horizontal and vertical values and cumulative weight values as represented by the equations:

Δθᵢ=candidate point θᵢ−intended point θᵢ

Sum Sin=Sum Sin+Sin(Δθᵢ)(Wᵢ)

Sum Cos=Sum Cos+Cos(Δθᵢ)(Wᵢ)

Sum Weights=Sum Weights+Wᵢ

The angular variance can be defined as 1−∥R∥/Sum Weights and can represent the angular similarity of the candidate word to the intended input word.

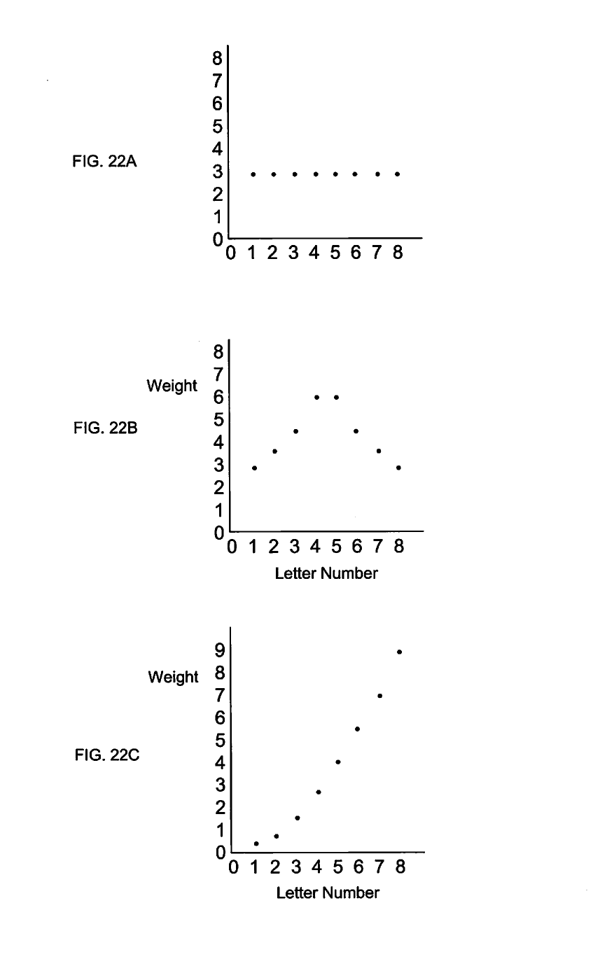

Weights can be applied to each sequential point in the input word. With reference to FIGS. 22A-22C, a graphical representation of the different weights are illustrated with the lower horizontal X axis representing the sequential input points and the vertical Y axis representing the weight value. In an embodiment, the weight values can be uniform for all input points as shown in FIG. 22A. In other embodiments, the weight values can be variable symmetric as shown in FIG. 22B. In a variable symmetric weight scheme, the weights can be applied in a symmetric manner to the points such that the weights for one group of input points are symmetric with the weights for another group of points. In this example, the weights for input points 1-4 are symmetric to the weights for input points 5-8. In another embodiment, the weights can be applied in a variable asymmetric manner as shown in FIG. 22C. In this example, the weights for the input points increase asymmetrically with the increased input number. In other embodiments, any other suitable weighting can be applied to the input points.

In order to determine the prospective words to compare the intended input word to, with reference to FIG. 1, the processor 103 can be coupled to a dictionary 105 or database of words and their corresponding polar or log polar coordinates. The matching of the candidate words to the intended input word can be done in different ways. For example, in an embodiment, a multi step process can be used. In the first step, the candidate words can be determined based upon the number of points in the input intended word shape. Then, each candidate word can be compared to the input radial data and given a radial similarity score. Words that have shape scores above a certain threshold value are eliminated and the next candidate word is analyzed. Similar processing of the angularity similarity can be performed and candidate words below a threshold value can be eliminated. This process can continue until there is a much smaller group of candidate words.

The dictionary may store words by their normal spelling as well as by the number of points and in groups by prefix. Because the shape of a word is based upon the number of points, the system may initially only search for matching word shapes that have the same number of points. In addition, the system can also search based upon prefixes. Each prefix of points may represent a distinct shape and the system can recognize these prefix shapes and only search words that have a matching prefix shape. Various other search processes can be performed to optimize the dictionary search results.

In an embodiment and for illustrative purposes, the invention will be described with a touch pad as the input device and the letter layout in a QWERTY format. A user will touch a touch sensitive input device based upon the relative positions of a QWERTY type keyboard in a sequence to type in words. A keyboard can be displayed on the touch sensitive input device as a guide for the user. However, the user is not restricted to touching the areas of the screen defined by the displayed keyboard. In an embodiment, with reference to FIG. 5, a keyboard can be displayed and the locations of the different letters can be shown with each of the letters having different X and Y coordinates on the input device. In contrast to this type of fixed keyboard, the present invention may be thought of as a virtual keyboard that can be located in any motion detection space. The center of the virtual keyboard moves with the user's input points and the center of the user's typing area can be X′=0, Y′=0 with the X′ axis along a horizontal direction and the Y′ axis extending from the top to the bottom of the virtual keyboard. Letters on the upper right such as U, I, O, P will have a X_{UIOP} and Y_{UIOP}, letters on the lower right such as B, N, M will have X_{BNM} and Y_{BNM}, letters on the upper left such as Q, W, E, R will have X_{QWER} and Y_{QWER} and letters on the lower left such as Z, X, C, V will have X_{ZXCV} and Y_{ZXCV}. Since the X and Y values are relative, the relationship between the different X and Y values can be X_{UIOP}>X_{QWER}, X_{BNM}>X_{ZXCV}, Y_{QWER}>Y_{ZXCV} and Y_{UIOP}>Y_{BNM}.

As the user types, each word can be represented by a sequence of detected point locations. The system will record and analyze these sequences of point positions for each word that is typed into the input device and determine a geometric shape for each word based upon the relative positions of the touch points. Because each word has a unique spelling, each word may most likely have a unique geometric shape. However, two words may have a similar pattern. A first pattern may represent a word typed right side up and a second pattern may represent a word typed upside down. The system can utilize additional information such as the orientation of the input device, the orientation of adjacent words, etc. to determine the proper orientation of the input pattern.

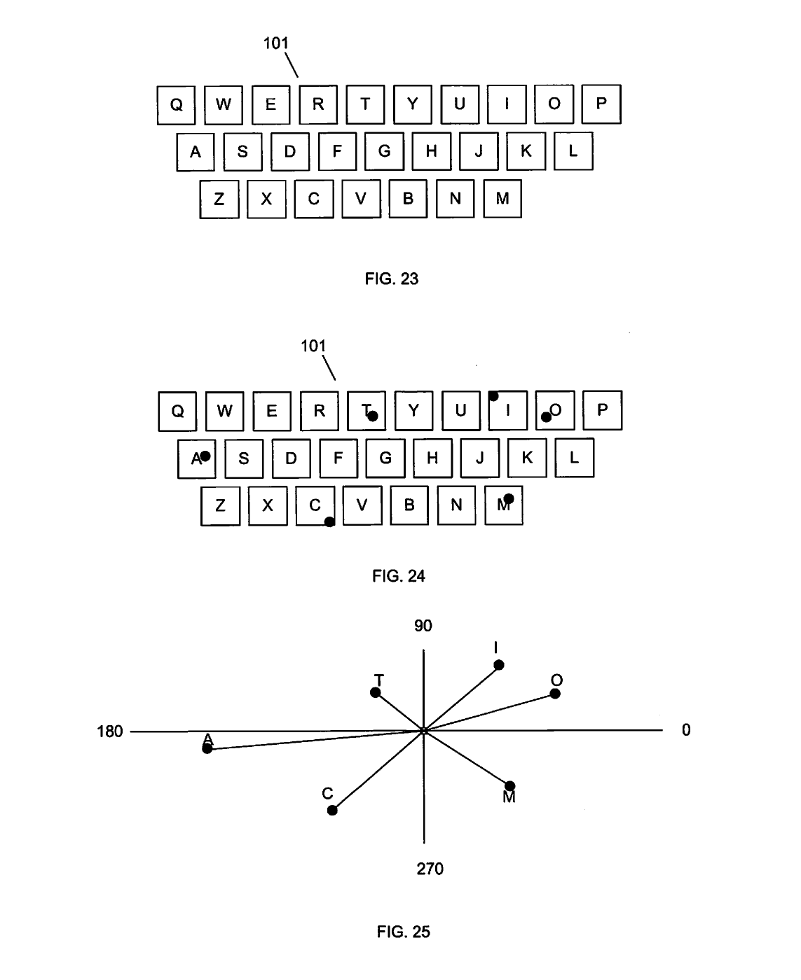

FIGS. 23 and 24 illustrate a virtual keyboard input device 101 and a user can type in words by sequentially placing a part of the body through the letters in the plane of the virtual keyboard that spell the word. In FIG. 24, the word “atomic” can be represented by the sequence of six virtual points on the virtual keyboard. With reference to FIG. 25, as discussed above, the locations of the touch point can be converted to anchor point relative points based upon their positions relative to the anchor point as previously defined. From the anchor center point 0, 0 point on the plane of the virtual keyboard, the radial distances and the angular values for each point of the input intended word can be determined.

Since the location detection is completely independent of any markings or floating points in space, a keyboard does not have to be displayed at all. Because the words are based upon the geometric shape rather than the specific locations of the points that are typed, the inventive system is not confined to a defined keyboard area of the input device. The user can type the words in any scale and in any rotation or translation on the input device and the system will be able to determine an intended word. Because many users may be able to touch type and be familiar with the relative locations of the different alphabetical keys, these users can type in any space that is monitored by a motion detection input device. By eliminating the keyboard, the entire display is available for displaying other information.

Because the system analyzes the shapes of words, an indication of when a word starts and ends may be needed. When people type, the words are separated by a space or a punctuation mark. Thus, in an embodiment, the space key can signal the beginning of a word and a space or a punctuation key may indicate the end of a word. In other embodiments, a user may wish to avoid the space and punctuation keys all together. In these embodiments, the user may signal the end of a word through the input device in any way that is recognized by the system. For example, the user may make a swipe gesture with a finger or hand to indicate that a word is completed. In other embodiments, any other detectable gesture or signal can be used to indicate that the word is finished. In yet other embodiments, the user may continuously type words as described without any spaces or punctuation between the words. The system may be able to automatically interpret each of the different words in the user's typing and separate these words.

An initial comparison can be performed between the intended word shape that is input and the corresponding geometric information of known words in the dictionary. The system may only make the initial comparison of the radial similarity of the first intended word to dictionary words that have the same number of points. The comparison will result in a calculated value which is the radial similarity score for each of the candidate words in the dictionary. A similar process can be performed for the angular similarity analysis. In an embodiment, the system may display one or more words that are most radially and angularly similar to the pattern input into the touch sensitive device. The user can then input a signal that the displayed word is the correct intended word.

Based upon the transformation analysis, the known candidate words are each given a transformation score which can be defined as a function of the scale factor, average angle and Δ of the anchor point found for each candidate when compared against the input. The system can then add additional factors to the transformation score. For example, in an embodiment, the system can add frequency values. For example, the total score of a candidate word can be the transformation score+the shape score+the frequency score. The frequency score can be based upon the normal usage of the candidate word and/or the user's usage of the candidate word. The normal usage of the candidate word can be the rating usage relative to other words in normal language, publications, etc. The user usage score can be based upon the user's specific use of the candidate word. During use, the system can detect when each word is used by a user. The system can analyze all of the user's writing and determine what words the user tends to use and create higher user ratings for commonly used words and lower ratings for infrequently used words. If the candidate word is a commonly used word in general and a commonly used word by the user, the system can account for this by increasing the total score for that candidate word making this candidate word more likely to have the highest total score. In contrast, if the candidate word is uncommon and not frequently used in general or by the user, the system can produce a lower frequency score reducing the probability this word will have the highest total score. The system can determine if there are additional saved candidate words. If there are more saved candidate words, the additional processing is repeated. The system can store the user data and use this data to more accurately predict the candidate words in the future.

In some cases, the user may not input the correct number of points into the input device. In these situations, the geometry of the intended word will not correspond to the geometry of the correct candidate word. In an embodiment, the system will analyze the geometric shape of the word with an additional location between each pair of adjacent locations for the shape of the intended word. For example, the intended word is COMPUTER, but the user may have omitted the letter M and inputted a sequence of points for COPUTER. The system may not find a good candidate based upon the shape and translation analysis. The system can then perform a separate analysis based upon missing points. Normally, the system will only search for words that have the same number of points that were inputted. However, if a good match is not found, the system can search candidate words that have one additional point. In this example, the system will look at all possible candidate words that have 7 points rather than 6 points. The system can analyze all candidate words by looking at the shapes of the candidate words with one point missing. For example, for the candidate word, “computer,” the shapes of _omputer, c_mputer, co_puter, com_uter, comp_ter, compu_er, comput_r, and compute_will be compared to the shapes of the input word shape. The same described analysis can be performed and the correct candidate word can be determined even though one point was missing from the input.

A similar process can be used to identify the correct candidate word when one extra point is included. For example, the user may have input points corresponding to the points, “commputer”. In this case, the system will compare the shape of all variations of the input, excluding one input point at a time. Thus, the system will analyze the shape of the text: _ommputer, c_mmputer, co_mputer, com_puter, comm_uter, commp_ter, commpu_er, commput_r, and commpute_. Again, the shapes of the modified input word will be compared to the input word shape using the described shape score comparison process. While the process has been described for one missing and one additional letter, similar processes can be used for multiple missing or multiple additional letters or combinations of missing and extra letters.

In another embodiment, the system may also be able to analyze swapped points. For example, a user may have swapped two adjacent points. If the user inputs “compuetr,” the system will look at the shapes of candidate words with two points swapped. For the candidate word, “computer,” the system would analyze the input word based upon a swapping of the adjacent points such as: ocmputer, cmoputer, copmuter, comupter, comptuer, computer and compuert or any other combination of swapped points. The system would make the match when the proper points are swapped based upon the described shape and translation processes.

The lack of tactile feedback in the task of typing, combined with a potential lack of direct visual feedback, is likely to make typing difficult on a 3-D input environment without the assistance of auto-correct functionality. The inventive system provides a method for providing an auto-correct functionality for typing in a 3-dimensional environment. In a first iteration, the system will record tap gestures as defined above. For each tap, the system will record the (x, y, z) coordinates of the tap in a defined 3-dimensional space. The system will continue to record tap gestures until the user effects a gesture corresponding to inputting a space character, or to invoking an auto-correct system.

In a second iteration, the system will use a technique such as multiple linear regression with the least squares method to deduce a typing plane of a virtual keyboard. It will then calculate positions of revised points projected onto this plane, such that a 2-dimensional set of points can be created. This step can be skipped if taps are defined as crossing or contacting a virtual keyboard plane. In these embodiments the virtual keyboard plane is given a predefined location in the movement detection space and doesn't have to be inferred.

Given the lack of tactile and direct visual feedback for the user in a 3-dimensional typing environment, it is likely that the input from the user will not accurately correspond to buttons pressed on the virtual keyboard. Errors could be introduced from inaccurate movement of the user's body, which would affect the precise locations of recognized tap gestures. Additionally, the inference of a virtual keyboard and projection of these gestures onto the keyboard is also likely to contain a degree of error.

The auto-correct module can then use a plurality of techniques to provide auto-correct functionality, and therefore correct these errors. For example, once the user has completed typing a word, he can perform a gesture in the detected three dimensional space to notify the device that he has completed typing a word. In certain embodiments this will be with a swipe gesture. For example, a swipe can be a hand movement in the space detection volume. For example, in an embodiment, a hand swipe from left to right in the sensor detection space may indicate that the typed word is complete. In other embodiments the gesture indicating the completed word may be a tap at a specific area of the sensor detection space. For example, the specific area of the sensor detection space may be where a virtual “space button” is designated.

The inventive system will process the user's input, and infer the word that the system believes the user most likely intended to enter. This corrective output can be based upon processing the input of the user's letter taps within the sensor detection space in combination with heuristics, which could include the proximity to the virtual keys in the sensor detection space, the frequency of use of certain words in the language of the words being typed, the frequency of certain words in the specified context, the frequency of certain words used by the writer or a combination of these and other heuristics.

Based upon the described analysis and processing, the device can output the most likely word the user intended to type and replace the exact input characters that the user had input. The output may be on a screen, projector, or read using voice synthesizer technology to an audio output device.

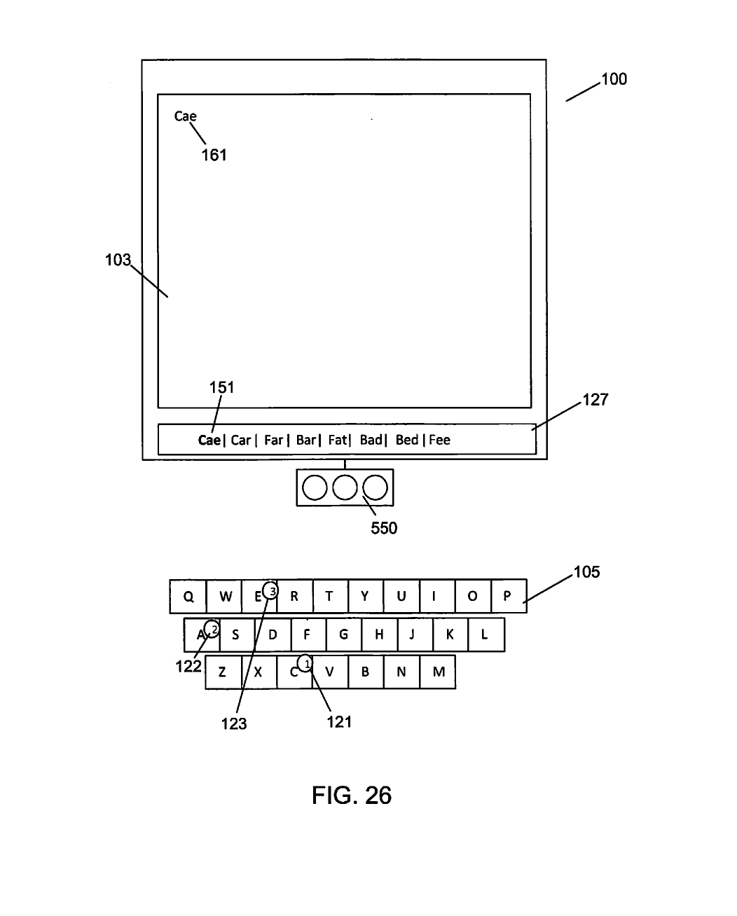

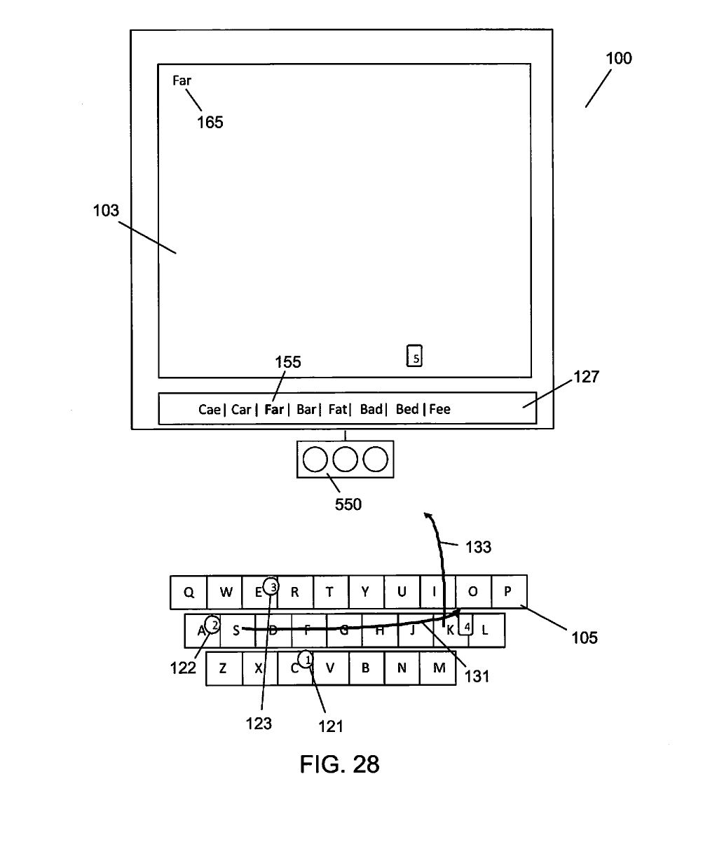

FIGS. 26-30 illustrate virtual keyboards in a three dimensional sensor detection space and visual displays that are separate from the virtual keyboard and the sensor detection space. (See log polar information above.) For example, with reference to FIG. 26, the user can use the inventive system and tap at points (1) 121, (2) 122 and (3) 123 which are respectively near letters C, A and E on the virtual keyboard 105 in the sensor detection space. The system may initially display the exact input text “Cae” 125 corresponding the locations and sequence of the tap gestures on the sensor detection space. The system may automatically respond to this input by altering the input text. Because this is the first word of a possible sentence, the first letter “C” may automatically be capitalized. The system may also automatically display possible intended words including: Cae, Car, Far, Bar, Fat, Bad and Fee on a possible word area 127 of the display 103. The current suggested word “Cae” may be indicated by bolding the text as shown or by any other indication method such as highlighting, flashing the text, contrasting color, etc. In this example, the text “Cae” 151 is bold. Although Cae 151 is not a complete word, the three letters may be the beginning of the user's intended word. The system can continue to make additional suggestions as letters are added or deleted by the user through the input touch screen.

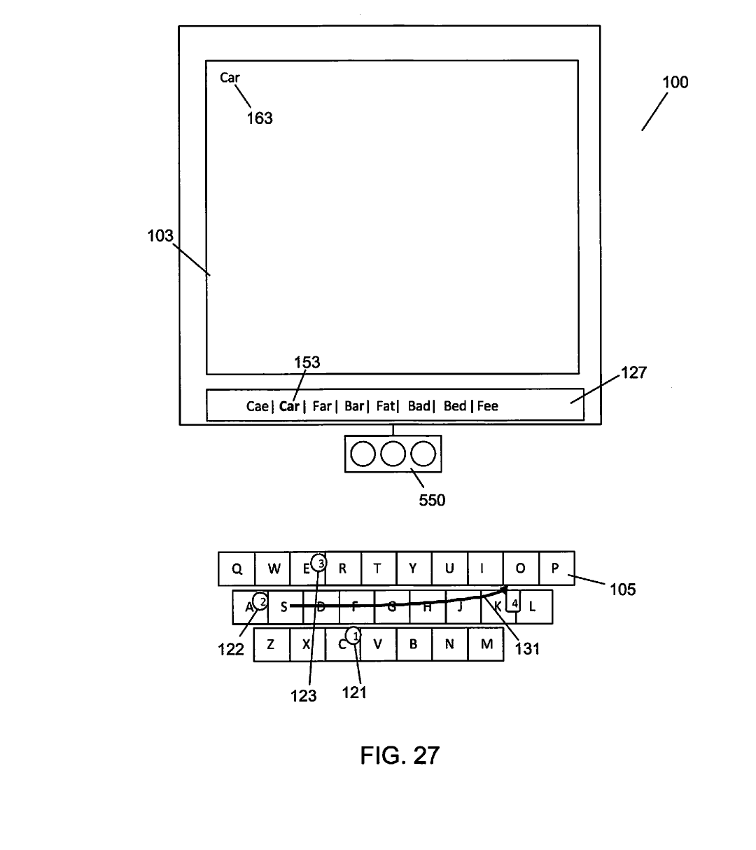

With reference to FIG. 27, in this example, the input text “Cae” may not be what the user intended to write. The user may view or hear the input text and input a command to correct the text. In order to actuate the correction system, the user can perform a swipe gesture within the sensor detection space that the system recognizes as the gesture for word correction. In an embodiment, the word correction gesture can be a right swipe 131, as indicated by swipe line 4. This right swipe gesture 131 can be recognized by the system as a user request to select the suggested word to the right. The system may respond to the word correction right swipe gesture 131 by replacing the input text “Cae” with the first sequential word in the listing of suggestions which in this example is “Car” 135. The text “Car” can be displayed in bold text in the possible word area 127 to indicate that this is the currently selected replacement word. The system can also replace the text “Cae” with the word “Car” 129 on the display 103.

The system can also perform additional auto-corrections and manual corrections. Following on from the previous example shown in FIGS. 26 and 27, FIG. 28 is another example of the behavior of an embodiment of the system. If the desired word is not “Car”, the user can perform another gesture in the sensor detection space to select another possible replacement word. In this example, the user's upwards swipe 133 indicated by line 5 may cause the system to replace the first replacement suggestion “Car” with the next suggestion “Far” 155 to the right. Again, the system can respond by displaying the word “Far” 155 in bold text in the possible word area 127 and changing the word “Car” to “Far” in the display 103.

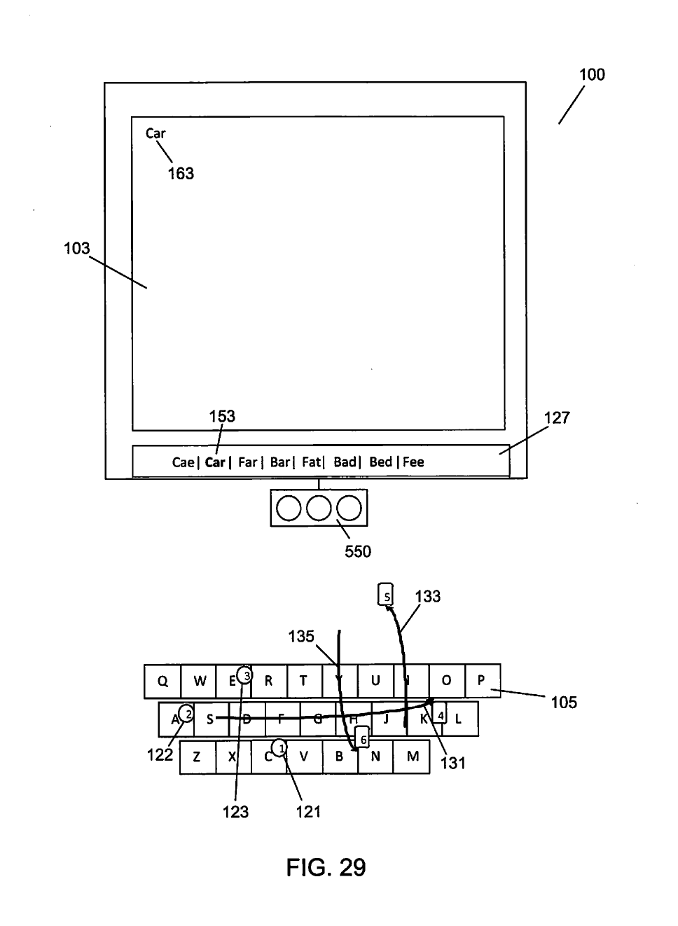

This described manual word correction process can proceed if necessary through the sequential listing of words in the possible word area 127. An additional upward swipe performed again would replace the second suggestion with the third suggestion “Bar” to the right and each additional upward swipe can proceed to the next sequential word to the right in the possible word area 127. Conversely with reference to FIG. 29, a subsequent downward swipe 135 in the sensor detection space indicated by line 6 could cause the system to replace the current suggestion “Far” with the previous one which is the sequential word to the left, “Car” 153. Repeating the downward swipe can result in the system selecting and displaying the next word to the left. If the selected word is the last word on the left side of the possible word area 127, the system can either not change the selected word or scroll around to the right side of the possible word area 127 and then select/display each word to the left with each additional downward swipe in the sensor detection space.

In other embodiments, the swipes gestures in the sensor detection space used to change the highlighted word in the possible word area 127 can be a right swipe for forward scrolling and a left swipe for reverse scrolling. In an embodiment, a single swipe in a first direction can cause scrolling to the right or forward and a swipe in a direction opposite to the first direction can cause reverse scrolling to the left. The first direction can be up, down, left, right, any diagonal direction, up/right, up/left, down/right and down/left. In other embodiments, any other type of distinctive gestures or combination of gestures can be used to control the scrolling. Thus, rather than automatically inputting the first suggested word, the system may allow the user to control the selection of the correct word from one or more listing of suggested words which can be displayed in the in the possible word area 127.

In an embodiment, the user can perform a swipe in a distinct direction in the sensor detection space to the scrolling gestures to confirm a word choice. For example, if up swipes and down swipes are used to scroll through the different words in the displayed group of possible words until the desired word is identified. The user can then perform a right swipe to confirm this word for input and move on to the next word to be input. Similarly, if left and right swipes are used to scroll through the different words in the displayed group of possible words, an up swipe can be used to confirm a word that has been selected by the user.

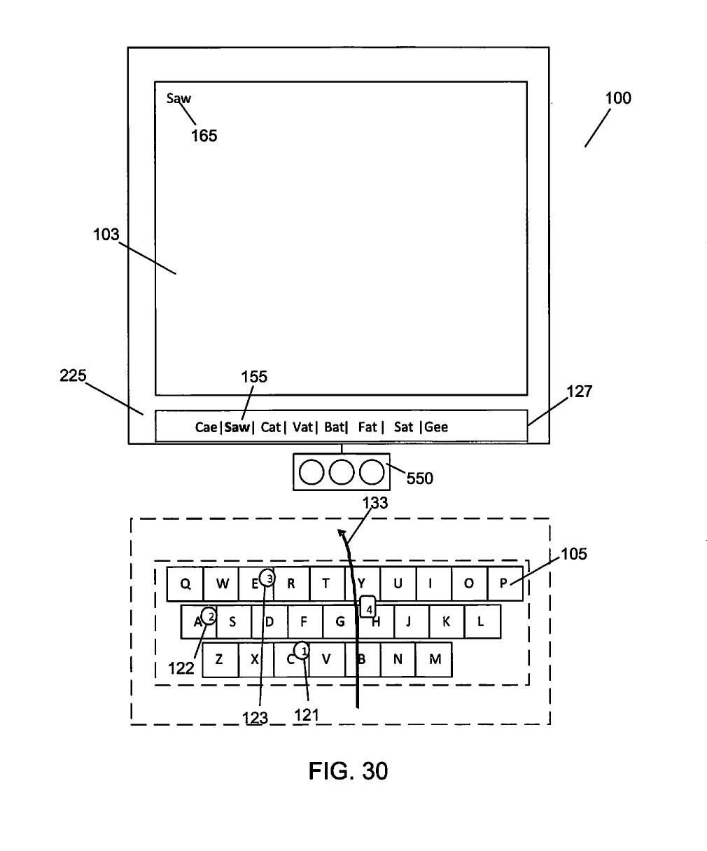

If the system's first suggestion is not what the user desired to input, the user may be able to request the system to effectively scroll through the first set of suggested words as described above. However, if none of the words in the first set of suggested words in the possible word area 127 are the intended word of the user, the system can provide additional sets of suggested words in response to the user performing another recognized swipe gesture. A different gesture can be made in the sensor detection space and recognized by the system to display a subsequent set or suggested words. For example with reference to FIG. 30, the additional suggestions gesture may be an up swipe 133 from the bottom of in the sensor detection space in a boundary region 225 to the top of the sensor detection space as designated by line 4.

The system will then replace its first listing of suggestions with a second listing, calculated using one or more of the heuristics described above. The second set of suggested words: Cae, Saw, Cat, Vat Bat, Fat, Sat, Gee . . . may be displayed on the touch screen display 103 device where the first listing had been. Because the word correction has been actuated, the second word, “Saw,” 165 in the possible word area 127 has been displayed on the screen 103 and “Saw” 155 is highlighted in bold. Note that the detected input text, “Cae,” may remain in the subsequent listing of suggested words in the possible word area 127. The user can scroll through the second listing of words with additional up or down swipes in the sensor detection space as described. This process can be repeated if additional listings of suggested words are needed.

In order to simplify the detection of swipes starting at the lower edge of the sensor detection space, the system may have a predefined edge region 225 around the outer perimeter of the entire sensor detection space. In an embodiment, the edge region 225 can be defined by a specific measurement from the outer edge of the display 103. For example, the edge region 225 can be a predefined distance between an inner sensor detection space and an outer sensor detection space. For example, the edge region 225 may be a distance between about 1-6 inches or any other suitable predefined distance, such as 3 inches that defines the width of the edge region 225 of the display 103. When the system detects an upward swipe commencing in the predefined edge region while in the word correction mode, the system can replace the current set of suggested works in the suggested word area 127 with a subsequent set of suggested words. Subsequent up swipes from the edge region of the sensor detection space can cause subsequent sets of suggested words to be displayed. In an embodiment, the system may cycle back to the first set of suggested words after a predefined number of sets of suggested words have been displayed. For example, the system may cycle back to the first set of suggested words after 3, 4, 5 or 6 sets of suggested words have been displayed. In other embodiments, the user may input a reverse down swipe gesture in the sensor detection space that ends in the edge region to reverse cycle through the sets of suggested words.

Note that the sequence of gestures used to scroll through the displayed possible words can be different than the gesture used to change the listing of displayed possible words. The sequence for scrolling through the displayed possible words in the described examples is letter input taps followed by a right swipe in the sensor detection space to start the manual word correction process. Once the word selection is actuated, the user can perform up or down swipes in the sensor detection space to sequentially scroll through the listing of words. In contrast, an immediate up swipe can actuate the manual word correction process by changing the listing of displayed possible words in the possible word area 127. With the second listing of words displayed in the possible word area 127, the user can sequentially scroll through the listing of words with up or down swipes as described above.

As soon as the user agrees with the system suggestion, the tapping process in the sensor detection space for inputting additional text can be resumed. In an embodiment, the tapping can be the gesture that indicates that the displayed word is correct and the user can continue typing the next word with a sequence of letter tapping gestures. The system can continue to provide sets of words in the possible word area 127 that the system determines are close to the intended words.

In other embodiments, the system may require a confirmation gesture in the sensor detection space to indicate that the displayed word is correct before additional words can be inputted. This confirmation gesture may be required between each of the input words. In an embodiment, a word confirmation gesture may be an additional right swipe which can cause the system to input a space and start the described word input process for the next word. The confirmation gesture can be mixed with text correction gestures so that the system can recognize specific sequences of gestures. For example, a user may type “Cae” 161 as illustrated in FIG. 13. The user can then right swipe 131 to actuate the word correction function and the system can change “Cae” to “Car” 103 in the display as illustrated in FIG. 14. The user can then up swipe 133 to change “Car” to “Far” 165. The user can then perform another right swipe to confirm that “Far” is the desired word and the system can insert a space and continue on to the next word to be input.

The examples described above demonstrate that the user is able to type in the sensor detection space in a way that resembles touch typing on hardware keyboards. The inventive system is able to provide additional automatic and manual correct functionality to the user's text input. The system also allows the user to navigate between different auto-correct suggestions with single swiping movements.

The inventive system can be used to input text to a computer or console or mobile device, output to screen, or audio. The system can provide the users with the ability to project a virtual keyboard on screen and the user's movements to aid in typing or input accuracy. The inventive system can also have the ability to display a virtual keyboard and hand movements on a 3-D device such as 3-D television.

In an embodiment the system may include a user interface that allows a user to configure the inventive system to the desired operation. The described functions can be listed on a settings user interface and each function may be turned on or off by the user. This can allow the user to customize the system to optimize inputs through the touch screen of the electronic device.

The present invention has been described as being used with mobile electronic devices, which can include any portable computing device. For example, the inventive system is capable of operating as a text input system for an in-dash vehicle console. The inventive system can be used as a stand-alone system, in combination with a stock in-dash system, in combination with a global positioning system (“GPS”), in combination with a smart device or any other custom computerized in-dash system. The inventive system may also be provided as software downloaded to any computer operating system within a vehicle, or downloaded on a hardware device that is compatible with a vehicle or vehicle operating system.

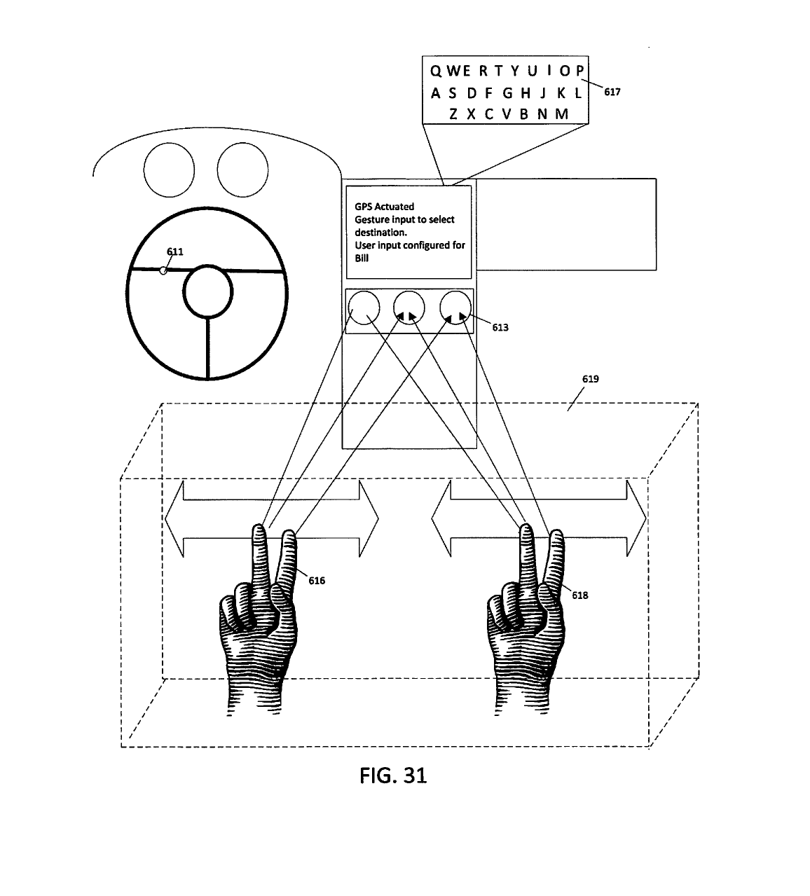

In the vehicle embodiment illustrated in FIG. 31, the user may press a specific button 611 on the steering wheel, use a gesture 613 to summon the console, audio command or otherwise indicate that the user is ready to interact with the three dimensional interface input system 615. The system may confirm that it is ready to receive gesture instruction with audio and/or visual indicators. The user may use the inventive system's various commands and controls such as: checking email, sending text messages, choosing a driving destination via GPS, choosing a specific song, or any other compatible interactions.

The vehicle embodiment of the system can allow the user to configure the system to the desired functionality of the specific user. The customization list will be located in the settings menu allowing the user to easily customize any and all desired functionality optimizing the typing experience for the specific user. The user may customize functionality such as language selection, input method, choose from different keyboard layout options, and any other customization that would benefit the specific user.

The vehicle embodiment of the system can also be capable of concurrently storing multiple users' desired settings allowing several users to easily access their specific settings with a simple body gesture. The user may wave with their left hand, give a thumb up with their right hand, or any other suitable gesture that could be used to communicate that they are a specific user requiring specific settings.

The system may project a three dimensional virtual keyboard, display a virtual keyboard (such as a QWERTY keyboard layout) 617 on the screen or surface to give the user keyboard letter organizational clues such as an outline, corners, some but not all letters of a virtual keyboard, or it may be an embodiment where all the visual clues are absent allowing the user to input letters based on memory. The vehicle embodiment of the system can rely on the four modules described above with reference to FIG. 1: Gesture recognizing module, Typing controller module, Autocorrect module and Output module. These modules will be used to recognize the user's intended input, provide some typing corrections and output the user's desired text. The above-mentioned process will be done on the backend of the software; from the user's perspective the system is simply outputting the intended input.

The sensor 613 coupled to the vehicle embodiment of the system can register an initial series of input locations of the body of the driver 616 and/or passenger 618 in the three dimensional space 619 associated with an intended word. The system can identify the initial set of X, Y and Z coordinate points associated with letters of the intended word. The system can then convert the initial set of X, Y and Z coordinate points into a Cartesian coordinate system with the origin at the weighted average of the first set of X, Y and Z coordinate points. The X, Y and Z coordinate points can then be converted into log polar coordinate points from an origin, each of the points having ρ and θ values. The system compares the initial set of radial distances to a set of log polar coordinate points associated with words stored in the dictionary. The system can compare the first set of angular values to angular values associated with the words stored in the dictionary and identifies the word stored in the dictionary that best matches the set of radial distances and the angular values that are the closest match to the set of angular values of the intended word. The system will repeat this process after each intended word.

In other embodiments the inventive system can also be used with wearable devices to input text or provide additional system inputs. Examples of electronic wearable devices include: smart watch (such as the Samsung Galaxy Gear, the Sony SmartWatch 2), smart lens (such as the Google Smart Contact Lens, the Microsoft Functional Contact Lens), smart glasses (such as the Google Glass, the Vuzix M100 Smart Glasses), and other types of wearable technologies. The inventive system can be provided as stand-alone hardware, in combination with a wearable device, in combination with a smart device, or the inventive system may be provided as software downloaded directly to any operating system or downloaded to a hardware system that is compatible with a wearable device.

The wearable embodiment of the system can have a settings menu where the user can optimize the interaction with the system based on the specific needs of the user. The settings menu can be invoked by waving the left hand, giving a thumb up with the right hand, drawing a FIG. 8 with the left hand in a detected space, or any other gesture suitable to invoke the settings menu. The settings menu could include settings pertaining to language selection, alternative keyboard layouts, theme settings and other customization that would optimize the typing experience specific to the user.

The system may project a three dimensional virtual keyboard, display a virtual keyboard on the screen to give the user letter-organization context, or the user will type based on memory without a display. The user would initiate the interaction with the inventive system by waving the right hand, giving a thumb up gesture with the right hand, drawing a counterclockwise circle with the left hand, or any other suitable gesture to initiate text input functionality.

The system can rely on the four modules described above: Gesture recognizing module, Typing controller module, Autocorrect module and Output module. These modules can be used to recognize the user's intended input, provide some typing corrections and output the user's desired input. The above-mentioned process can be done in the background of the software; from the user's perspective the system will simply output the intended input.

In an embodiment, the system does this by first registering a series of initial input locations of the body in the three dimensional space correlated with an intended word. The system can identify the initial set of X, Y and Z coordinate points associated with letters of the intended word. The system can convert the initial set of X, Y and Z coordinate points into a Cartesian coordinate system with the origin at the weighted average of the first set of X, Y and Z coordinate points. The X, Y and Z coordinate points can be converted into log polar coordinate points from an origin, each of the points having ρ and θ values. The system can compare the first set of radial distances to a set of log polar coordinate points associated with words stored in a dictionary. The system can identify the word stored in the dictionary that best matches the set of radial distances and the angular values that most closely match the set of angular values of the intended word. The system then outputs the intended word within milliseconds. The system will repeat this process for each intended word.

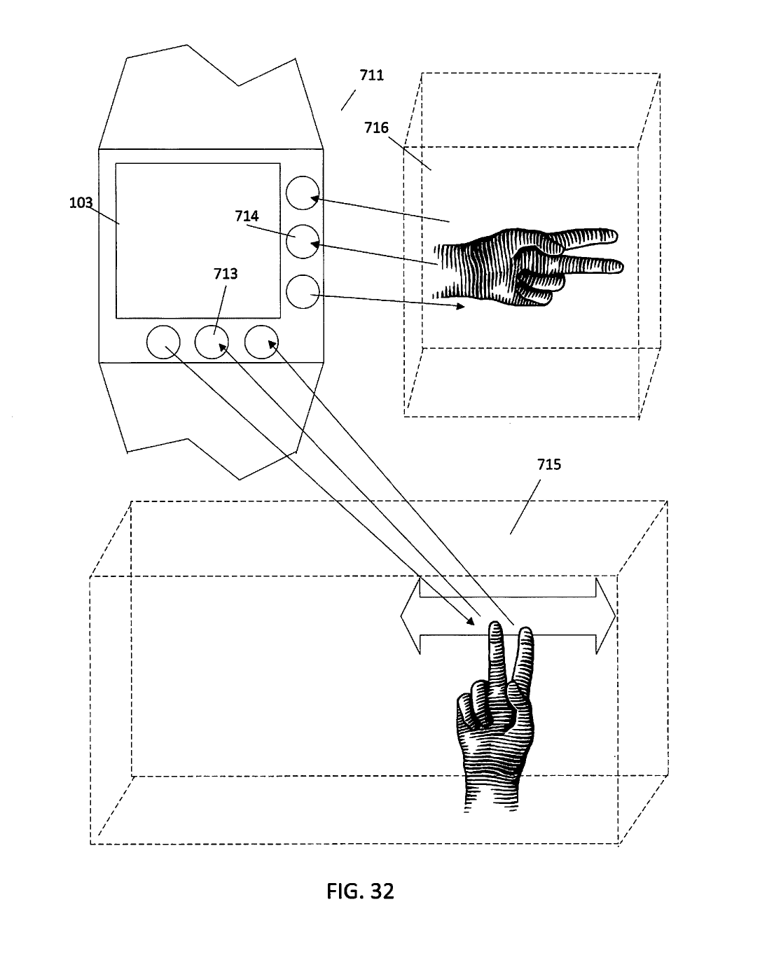

With reference to FIG. 32, a smart watch embodiment is illustrated which includes a sensor 713 built into the smartwatch 711 that can include a visual display screen 103. The sensor 713 can detect movement within a 3-dimensional space 715. In the watch embodiment, the detected gestures can be limited to a single hand because the hand that the smartwatch 711 is worn on may not be detectable by the sensor 713. In other embodiments, the smartwatch may include a first sensor 713 for detecting movements and gestures of a first hand and a second sensor 714 for detecting movements and gestures of a second hand in a smaller closer 3-dimensional space 716.

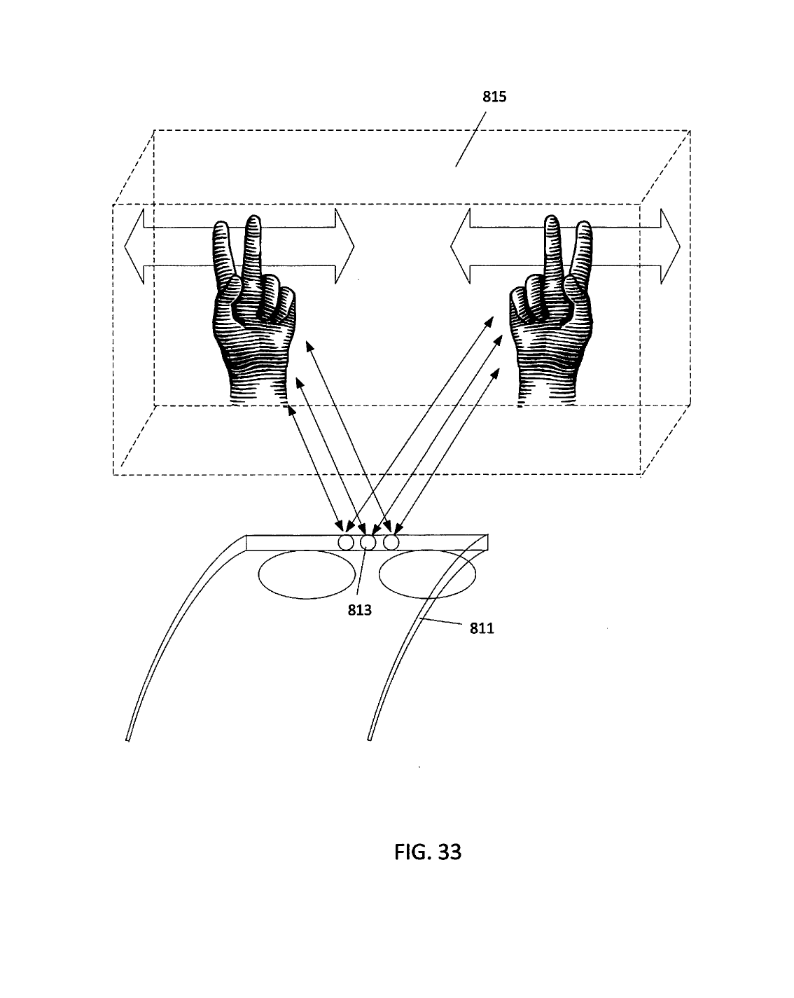

With reference to FIG. 33, a smart glasses embodiment is illustrated. In this embodiment, the smart glasses 811 can include a sensor 813 that detects movement within a 3-dimensional space 815. In this embodiment, the system can detect gestures from one and/or two hands within the 3-dimensional space 815 as described above. Because the smart glasses sensor 813 is detecting the hands from the user's perspective rather than from a vantage point away from the user, the detected left hand and right hand gestures may have to be corrected.

It will be understood that the inventive system has been described with reference to particular embodiments, however additions, deletions and changes could be made to these embodiments without departing from the scope of the inventive system. Although the order filling apparatus and method described include various components, it is well understood that these components and the described configuration can be modified and rearranged in various other configurations.

What is claimed is:

1. A text input method comprising:
providing a sensor for detecting positions of portions of the body in a three dimensional space, the sensor transmitting position information to a processor;
detecting by the sensor, a first sequence of input locations of portions of the body in the three dimensional space associated with an intended word;
defining a virtual keyboard plane by a processor, based upon a first three or more inputs of the sequence of input locations;
identifying by the processor, a word stored in a dictionary that most closely matches the relative positions and the sequence of input locations on the virtual keyboard in the three dimensional space; and
inputting by the processor, the word to a sequence of input text.

2. The text input method of claim 1 wherein the identifying step includes:
identifying a first set of radial distances relative to an origin on the virtual keyboard plane associated with letters of the first intended word;
identifying a first set of angular values associated with the letters of the first intended word;
comparing the first set of radial distances to sets of radial distances associated with words stored in a dictionary; and
comparing the first set of angular values to sets of angular values associated with the words stored in the dictionary.

3. The text input method of claim 2 wherein the radial distances relative to the origin associated with letters of the first intended word are measured as log distances.

4. The text input method of claim 3 wherein the identifying step includes:
determining a standard deviation of the log distances.

5. The text input method of claim 3 wherein the identifying step includes:
applying weights to the standard deviation of the log distances.

6. The text input method of claim 1 further comprising:
displaying the intended word stored in the dictionary on a visual display.

7. The text input method of claim 1 further comprising:
detecting by the sensor, a space gesture movement of the body in the three dimensional space; and
inputting by the processor, a space to the sequence of input text.

8. The text input method of claim 1 further comprising:
detecting by the sensor, a punctuation mark gesture movement of the body in the three dimensional space; and
inputting by the processor, a punctuation mark to the sequence of input text.

9. A text input method comprising:
providing a sensor for detecting positions of portions of the body in a three dimensional space;
detecting by the sensor, a first sequence of input locations of portions of the body in the three dimensional space associated with an intended word;
identifying a first set of X, Y and Z coordinate points associated with letters of the first intended word;
converting the first set of X, Y and Z coordinate points into a Cartesian coordinate system with the origin at the weighted average of the first set of X, Y and Z coordinate points;
converting the X, Y and Z coordinate points into log polar coordinate points from an origin, each of the points having ρ and θ values;
comparing the first set of radial distances to a set of log polar coordinate points associated with words stored in a dictionary;
comparing the first set of angular values to a set of angular values associated with the words stored in the dictionary; and
identifying the word stored in the dictionary having the radial positions that most closely match the first set of radial distances and the angular values that most closely match the first set of angular values of the first intended word.

10. The text input method of claim 9 wherein the identifying step includes:
identifying a first set of radial distances relative to an origin on the virtual keyboard plane associated with letters of the first intended word;
identifying a first set of angular values associated with the letters of the first intended word;
comparing the first set of radial distances to sets of radial distances associated with words stored in a dictionary; and
comparing the first set of angular values to sets of angular values associated with the words stored in the dictionary.

11. The text input method of claim 10 wherein the radial distances relative to the origin associated with letters of the first intended word are measured as log distances.

12. The text input method of claim 10 wherein the identifying step includes:
determining a standard deviation of the log distances.

13. The text input method of claim 10 wherein the identifying step includes:
applying weights to the standard deviation of the log distances.

14. The text input method of claim 9 further comprising:
displaying the intended word stored in the dictionary on a visual display.

15. The text input method of claim 9 further comprising:
detecting by the sensor, a space gesture movement of the body in the three dimensional space; and
inputting by the processor, a space to the sequence of input text.

16. The text input method of claim 9 further comprising:
detecting by the sensor, a punctuation mark gesture movement of the body in the three dimensional space; and
inputting by the processor, a punctuation mark to the sequence of input text.

17. An text input method comprising:
defining by a processor, a virtual keyboard on a virtual plane in a three dimensional space, where the virtual plane is not on an object;
detecting by a sensor, a location of a portion of a body in the three dimensional space;
detecting by the processor, a sequence of intersections of the portions of the body with the virtual keyboard;
inputting by the processor, a sequence of letters corresponding to the intersections of the portions of the body on the virtual keyboard;
detecting by the processor a gesture in the three dimensional space that is not a letter input; and
performing by the processor a command associated with the gesture.

18. The text input method of claim 17 wherein the gesture is a wave.

19. The text input method of claim 18 wherein the command associated with the gesture is a space input.

20. The text input method of claim 17 wherein the gesture is a thumbs up.

21. The text input method of claim 20 wherein the command associated with the gesture is a backspace.

22. The text input method of claim 17 wherein the gesture is a left swipe and the command associated with the gesture is a back space.

23. The text input method of claim 1 wherein the gesture is a circular hand motion.

24. The text input method of claim 17 wherein the command associated with the gesture is a scrolling through a plurality of suggested words.
